(19) United States
(12) Patent Application Publication
(10) Pub. No.: US 2026/0044239 A1
(43) Pub. Date: Feb. 12, 2026

(54) ELECTRONIC DEVICE

(71) Applicant: Samsung Display Co., Ltd., Yongin-si (KR)

(72) Inventors: TAE HYUN KIM, Yongin-si (KR); GUN HEE KIM, Yongin-si (KR); SANG-HEE JANG, Yongin-si (KR); JOOHEE JEON, Yongin-si (KR)

(73) Assignee: Samsung Display Co., Ltd., Yongin-si (KR)

(21) Appl. No.: 19/244,412

(22) Filed: Jun. 20, 2025

(30) Foreign Application Priority Data
Aug. 12, 2024 (KR) 10-2024-0107616

(51) Int. Cl. G06F 3/044; G06F 3/041

(52) U.S. Cl. CPC G06F 3/0446; G06F 3/04164; G06F 3/0443; G06F 2203/04107

(57) ABSTRACT

An electronic device includes a display layer including a first display area in which a plurality of first pixels are disposed and a second display area in which a plurality of second pixels are disposed, a drive circuit that overlaps the second display area in a plan view, and a sensor layer disposed on the display layer and including a sensing area and a non-sensing area. The sensor layer includes a plurality of sensing electrodes disposed in the sensing area and a shielding line disposed in the non-sensing area and commonly overlapping some of the plurality of second pixels adjacent to a corner of the second display area in a plan view.

### CROSS-REFERENCE TO RELATED APPLICATION(S)

This application claims priority to and benefits of Korean Patent Application No. 10-2024-0107616 under 35 U.S.C. § 119, filed on Aug. 12, 2024, in the Korean Intellectual Property Office (KIPO), the entire content of which are incorporated herein by reference.

### BACKGROUND

### 1. Technical Field

Embodiments of the disclosure described herein relate to an electronic device, and more particularly, relate to an electronic device with improved display quality.

### 2. Description of the Related Art

Multimedia electronic devices, such as a television, a mobile phone, a tablet computer, a computer, a car navigation unit, a game machine, and the like, include a display panel for displaying an image.

Nowadays, to meet market demand, research is being conducted to reduce an area that does not display an image on a display device. At the same time, research is being conducted to expand a display area where an image is displayed on the display device and to improve visibility.

### SUMMARY

Embodiments of the disclosure provide an electronic device for improving display quality.

According to an embodiment, an electronic device may include a display layer including a first display area in which a plurality of first pixels are disposed and a second display area in which a plurality of second pixels are disposed, a drive circuit that overlaps the second display area in a plan view, and a sensor layer disposed on the display layer, the sensor layer including a sensing area and a non-sensing area.

The sensor layer may include a plurality of sensing electrodes disposed in the sensing area and a shielding line that commonly overlaps some of the plurality of second pixels adjacent to a corner of the second display area in a plan view and is disposed in the non-sensing area.

The sensor layer may further include an antistatic line disposed in the non-sensing area.

The shielding line may have a shape corresponding to the corner.

The shielding line may extend from the antistatic line.

The shielding line may be a portion of the antistatic line.

The plurality of second pixels may constitute a pixel cell, and the shielding line may have a blocking width corresponding to a size of the pixel cell.

The plurality of second pixels may constitute a pixel unit, and the shielding line may have a blocking width corresponding to a size of the pixel unit.

The shielding line may include a first shielding line and a second shielding line disposed on the first shielding line, and the plurality of second pixels may overlap at least one of the first shielding line and the second shielding line in a plan view.

The sensor layer may further include an intermediate insulating layer between the first shielding line and the second shielding line, and the intermediate insulating layer may be formed of an organic material or an inorganic material.

The first shielding line and the second shielding line may partially overlap each other in a plan view.

The second shielding line may be directly disposed on the first shielding line, the sensor layer may further include an intermediate insulating layer that covers the second shielding line, and the intermediate insulating layer may be formed of an organic material or an inorganic material.

The plurality of sensing electrodes may include a plurality of first sensing electrodes extending in a first direction and a plurality of second sensing electrodes extending in a second direction intersecting the first direction.

The sensor layer may further include a plurality of first trace lines electrically connected with the plurality of first sensing electrodes and a plurality of second trace lines electrically connected with the plurality of second sensing electrodes.

At least one of the plurality of first trace lines and the plurality of second trace lines may be disposed in the sensing area.

According to an embodiment, an electronic device may include a display layer including a first display area in which a plurality of first pixels are disposed and a second display area in which a plurality of second pixels are disposed, a drive circuit that overlaps the second display area in a plan view, and a sensor layer disposed on the display layer, the sensor layer including a sensing area and a non-sensing area.

The sensor layer may include a plurality of shielding patterns spaced apart from one another. The plurality of second pixels may be adjacent to a corner of the second display area and include shielded pixels overlapping the plurality of shielding patterns in a plan view and a non-shielded pixel not overlapping the plurality of shielding patterns in a plan view. Each of the shielded pixels may include an emissive area and a non-emissive area, and each of the plurality of shielding patterns may shield at least a portion of the emissive area of the shielded pixels.

The each of the plurality of shielding patterns may shield an area outside of the shielded pixels.

The each of the plurality of shielding patterns may shield an area inside the emissive area of the shielded pixels.

The each of the plurality of shielding patterns may entirely shield the emissive area of the shielded pixels.

The sensor layer may further include an antistatic line disposed in the non-sensing area.

The sensor layer may further include a plurality of sensing electrodes disposed in the sensing area. The plurality of sensing electrodes may include a plurality of first sensing electrodes extending in a first direction and a plurality of second sensing electrodes extending in a second direction intersecting the first direction. The sensor layer may further include a plurality of first trace lines electrically connected with the plurality of first sensing electrodes and a plurality of second trace lines electrically connected with the plurality of second sensing electrodes.

At least one of the plurality of first trace lines and the plurality of second trace lines may be disposed in the sensing area.

### BRIEF DESCRIPTION OF THE DRAWINGS

The above and other objects and features of the disclosure will become apparent by describing in detail embodiments thereof with reference to the accompanying drawings.

FIG. 1 is a perspective view of an electronic device according to an embodiment of the disclosure.

FIG. 2A is a schematic cross-sectional view of the electronic device according to an embodiment of the disclosure.

FIG. 2B is a schematic cross-sectional view of the electronic device according to an embodiment of the disclosure.

FIG. 3A is a schematic cross-sectional view of a display module according to an embodiment of the disclosure.

FIG. 3B is a schematic cross-sectional view of a display module according to an embodiment of the disclosure.

FIG. 4 is an enlarged schematic cross-sectional view of the display module according to an embodiment of the disclosure.

FIG. 5A is a plan view illustrating a display panel and a drive circuit according to an embodiment of the disclosure.

FIG. 5B is an enlarged view of area AA in FIG. 5A.

FIG. 6A is a plan view of an input sensor according to an embodiment of the disclosure.

FIG. 6B is a plan view of the input sensor according to an embodiment of the disclosure.

FIG. 6C is a plan view of the input sensor according to an embodiment of the disclosure.

FIG. 7 is an enlarged view illustrating area BB of FIG. 6A.

FIG. 8A is a schematic diagram illustrating an arrangement of second pixels in a second display area according to an embodiment of the disclosure.

FIG. 8B is a schematic diagram illustrating an arrangement of the second pixels in the second display area according to an embodiment of the disclosure.

FIG. 9A is a schematic diagram illustrating an arrangement of shielding lines according to an embodiment of the disclosure.

FIG. 9B is a schematic diagram illustrating an arrangement of shielding lines according to an embodiment of the disclosure.

FIG. 9C is a schematic diagram illustrating an arrangement of shielding lines according to an embodiment of the disclosure.

FIG. 9D is a schematic diagram illustrating an arrangement of shielding lines according to an embodiment of the disclosure.

FIG. 10A is a schematic diagram of the second pixels according to an embodiment of the disclosure.

FIG. 10B is a schematic diagram of the second pixels according to an embodiment of the disclosure.

FIG. 11A is a schematic cross-sectional view of the display module taken along line I-I′ of FIG. 10A.

FIG. 11B is a schematic cross-sectional view of the display module taken along line II-II′ of FIG. 10B.

FIG. 12 is a schematic block diagram of an electronic device, according to an embodiment of the disclosure.

### DETAILED DESCRIPTION OF THE EMBODIMENTS

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Also, when an element is referred to as being “in contact” or “contacted” or the like to another element, the element may be in “electrical contact” or in “physical contact” with another element; or in “indirect contact” or in “direct contact” with another element.

Identical reference numerals refer to identical components. Additionally, in the drawings, the thicknesses, proportions, and dimensions of components are exaggerated for effective description. As used herein, the term “and/or” includes all of one or more combinations defined by related components.

Terms such as first, second, and the like may be used to describe various components, but the components should not be limited by the terms. The terms may be used only for distinguishing one component from other components. For example, without departing the scope of the disclosure, a first component may be referred to as a second component, and similarly, the second component may also be referred to as the first component. The terms of a singular form may include plural forms unless otherwise specified.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

In the specification and the claims, the phrase “at least one of” is intended to include the meaning of “at least one selected from the group of” for the purpose of its meaning and interpretation. For example, “at least one of A and B” may be understood to mean “A, B, or A and B. ” In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

Unless otherwise defined, all terms used herein, including technical or scientific terms, have the same meanings as those generally understood by those skilled in the art to which the disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the application.

Hereinafter, embodiments of the disclosure will be described with reference to the accompanying drawings.

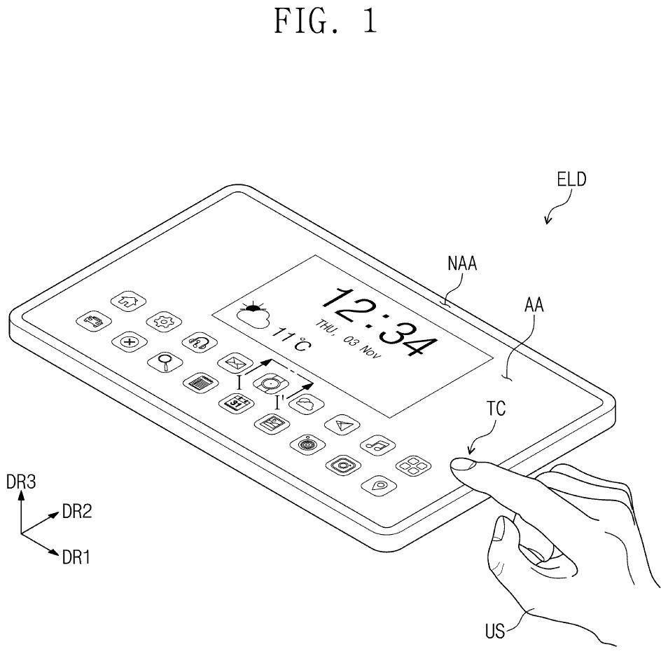

FIG. 1 is a perspective view of an electronic device according to an embodiment of the disclosure.

Referring to FIG. 1, the electronic device ELD may be a device activated depending on an electrical signal. For example, the electronic device ELD may be a mobile phone, a foldable mobile phone, a notebook computer, a television, a tablet computer, a car navigation unit, a game machine, or a wearable device, but the disclosure is not limited thereto. In FIG. 1, the electronic device ELD is illustrated as a tablet computer according to an embodiment.

The electronic device ELD may have an active area AA and a peripheral area NAA. The electronic device ELD may display an image through the active area AA. The active area AA may include a plane defined by a first direction DR1 and a second direction DR2. The peripheral area NAA may surround the periphery of the active area AA. In another embodiment of the disclosure, the peripheral area NAA may be omitted.

The thickness direction of the electronic device ELD may be parallel to a third direction DR3 that intersects the first direction DR1 and the second direction DR2. Accordingly, front surfaces (or, upper surfaces) and rear surfaces (or, lower surfaces) of members constituting the electronic device ELD may be defined based on the third direction DR3.

Although the electronic device ELD of a bar type is illustrated in FIG. 1, the disclosure is not limited thereto. For example, the following descriptions may be applied to various electronic devices such as a foldable electronic device, a rollable electronic device, and a slidable electronic device.

The electronic device ELD may sense an external input applied from the outside. The external input may include various inputs provided from outside the electronic device ELD. The electronic device ELD according to an embodiment may sense an input TC applied from the outside. The input TC may be an input by an input means such as a passive type. The input TC may include both an input by a body of a user US and an input capable of changing the capacitance of an input sensor. The electronic device ELD may sense the input TC of the user US applied to the side surface or the rear surface of the electronic device ELD depending on the structure of the electronic device ELD, but the disclosure is not limited to any one embodiment.

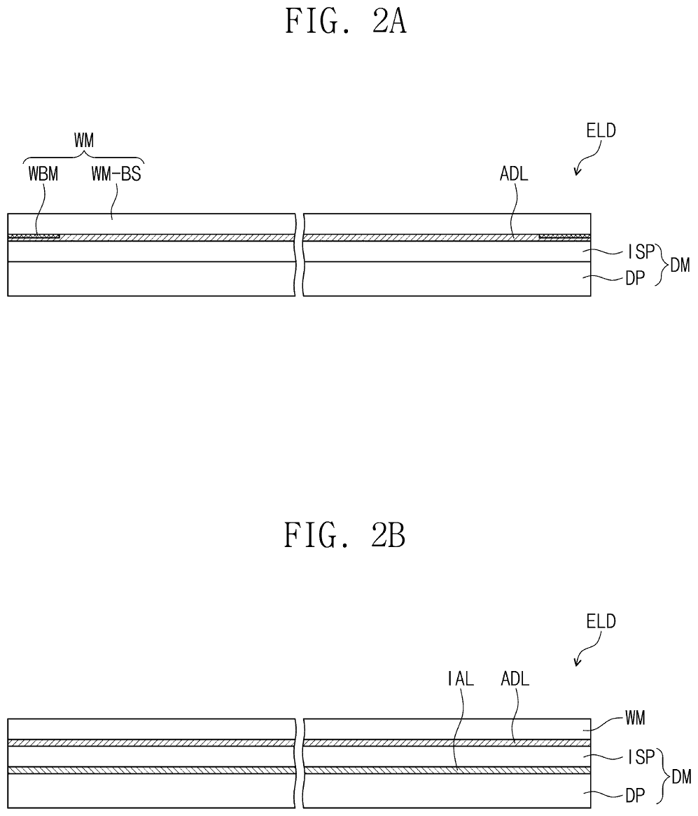

FIGS. 2A and 2B are schematic cross-sectional views of the electronic device according to embodiments of the disclosure.

Referring to FIG. 2A, the electronic device ELD may include a display module DM and a window WM. The display module DM may generate an image and sense an external input. The display module DM may include a display panel DP and an input sensor ISP. In this specification, the display panel DP may be referred to as a “display layer”, and the input sensor ISP may be referred to as a “sensor layer”.

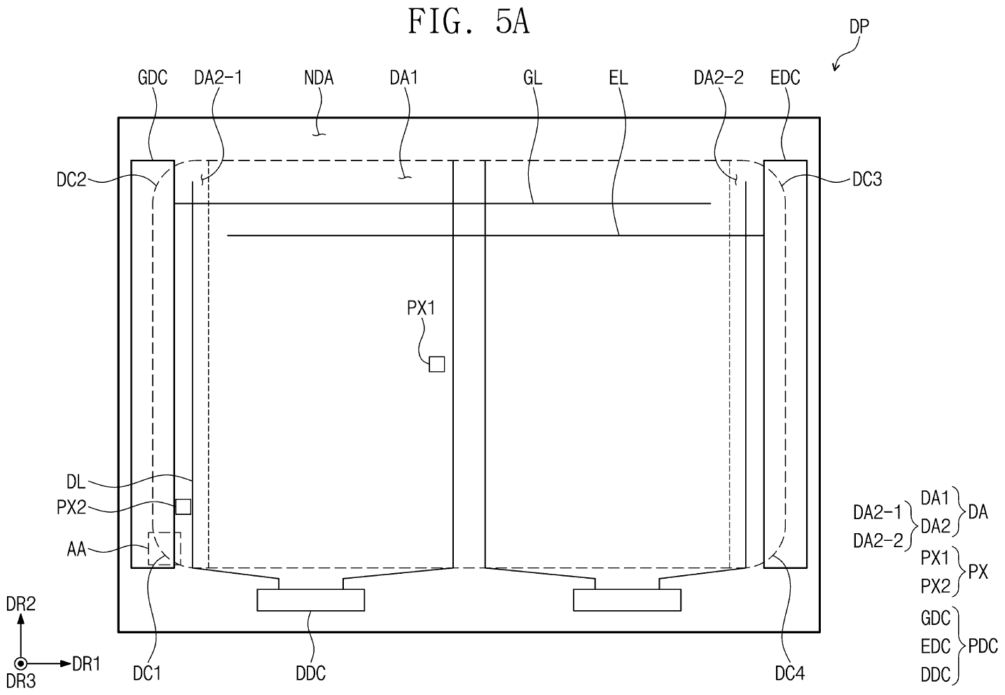

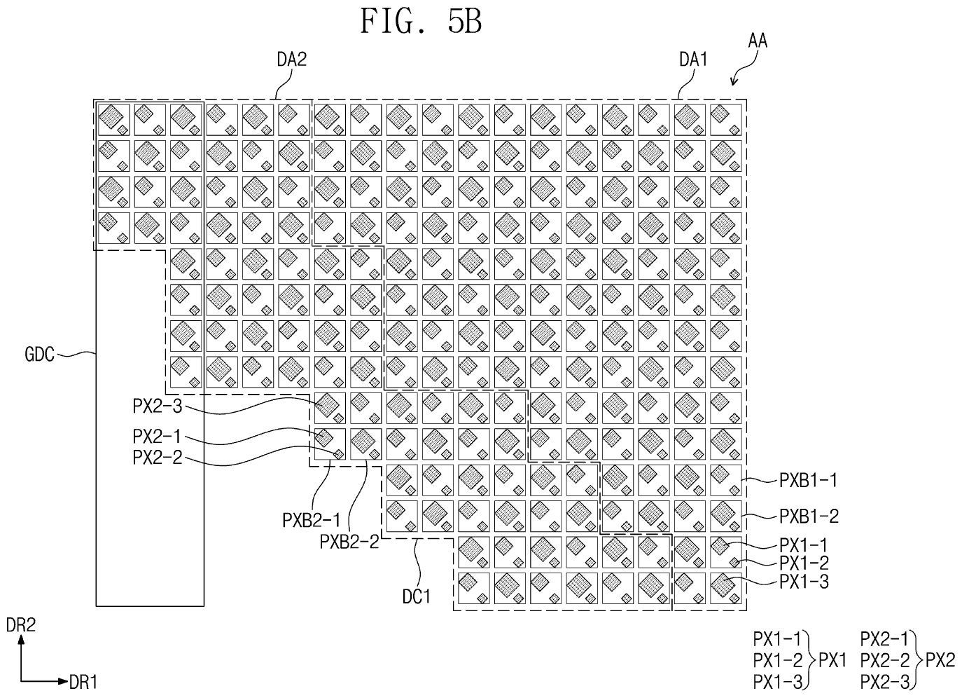

The display panel DP may include a display area DA (refer to FIG. 5A) and a non-display area NDA (refer to FIG. 5A) that correspond to the active area AA (refer to FIG. 1) and the peripheral area NAA (refer to FIG. 1) of the electronic device ELD, respectively.

The input sensor ISP may be directly disposed on the display panel DP. According to an embodiment of the disclosure, the input sensor ISP may be formed on the display panel DP by a continuous process. For example, in case that the input sensor ISP is directly disposed on the display panel DP, an inner adhesive layer IAL (refer to FIG. 2B) may not be disposed between the input sensor ISP and the display panel DP. However, the disclosure is not limited thereto, and in another embodiment, as illustrated in FIG. 2B, the inner adhesive layer IAL may be disposed between the input sensor ISP and the display panel DP, and the input sensor ISP may not be manufactured together with the display panel DP by a continuous process and may be manufactured separately from the display panel DP and fixed to the upper surface of the display panel DP by the inner adhesive layer IAL.

The electronic device ELD may further include an optical member (not illustrated) disposed on the display module DM. The optical member may be an anti-reflective layer capable of lowering the reflectance of external light. The optical member may include a polarizer and a phase retarder. The polarizer and the phase retarder may be of a stretchable or coating type. A stretchable-type optical film may have an optical axis defined depending on the stretching direction of a functional film. The coating-type optical film may include liquid crystal molecules arranged on a base film.

In another embodiment of the disclosure, the optical member may be omitted, and the display module DM may further include a color filter and a black matrix that replace the optical member. The color filter and the black matrix may be directly disposed on the upper surface of the input sensor ISP through a continuous process. The upper surface of the input sensor ISP may be provided by an insulating layer disposed on the uppermost side of the input sensor ISP.

The window WM may provide an outer surface of the electronic device ELD. The window WM may include a base substrate and may further include functional layers such as an anti-reflective layer and an anti-fingerprint layer.

In an embodiment, the display module DM may further include at least one adhesive layer ADL. The adhesive layer ADL may couple components of the display module DM. The adhesive layer ADL may be an optically clear adhesive layer or a pressure sensitive adhesive layer.

As illustrated in FIG. 2A, the window WM may include a light blocking pattern WBM for defining the peripheral area NAA (refer to FIG. 1). The light blocking pattern WBM may be a colored organic film and may be formed on a surface of a window base layer WM-BS, for example, by a coating method.

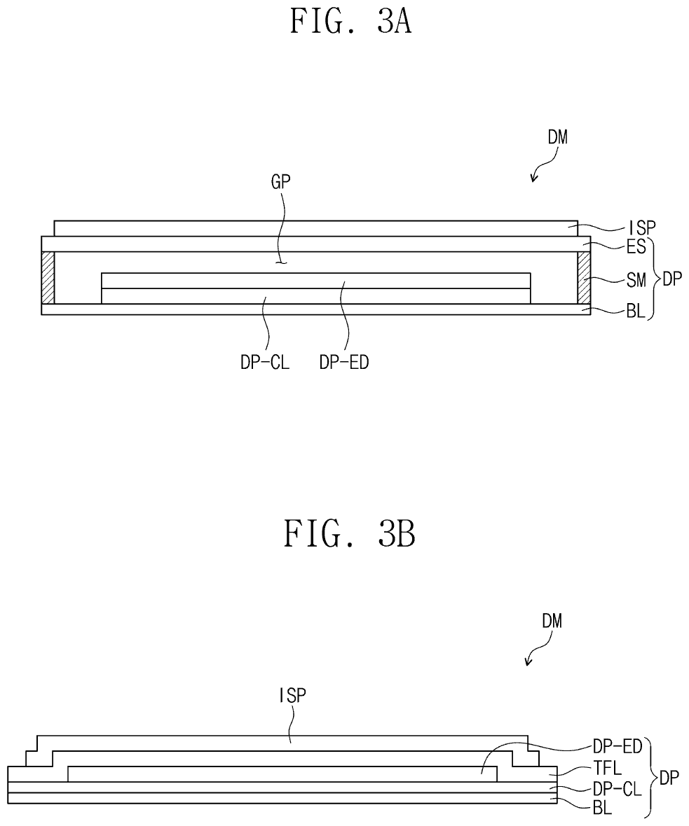

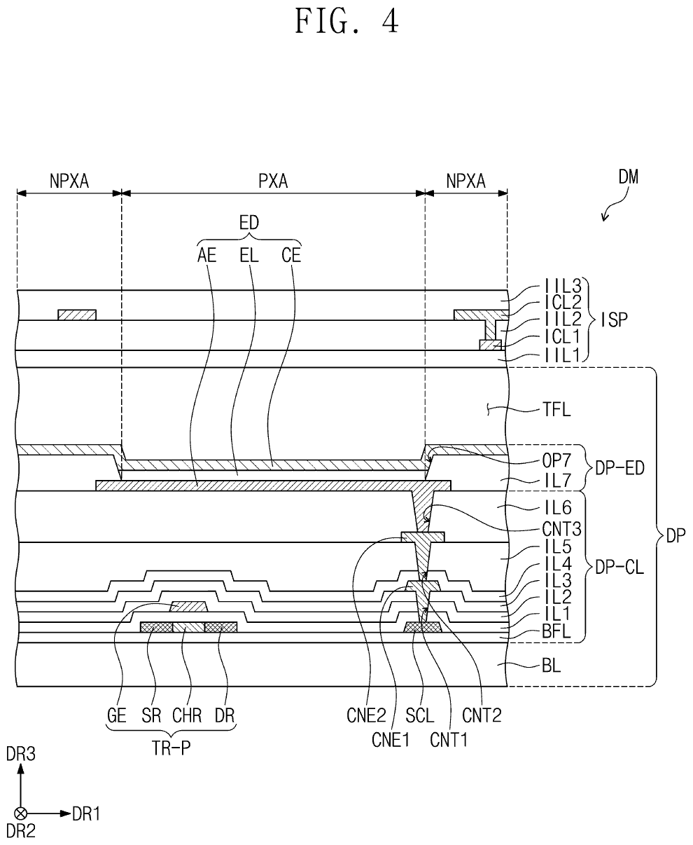

FIGS. 3A and 3B are schematic cross-sectional views of the display module according to embodiments of the disclosure.

Referring to FIG. 3A, the display panel DP may include a base layer BL, a circuit element layer DP-CL disposed on the base layer BL, a display element layer DP-ED, an encapsulation substrate ES, and a sealant SM that couples the base layer BL and the encapsulation substrate ES.

The base layer BL may include at least one plastic film. The base layer BL may include a plastic substrate, a glass substrate, a metal substrate, or an organic/inorganic composite substrate. In an embodiment, the base layer BL may be a thin film glass substrate having a thickness of tens to hundreds of micrometers. The base layer BL may have a multi-layer structure. For example, the base layer BL may include an organic layer (e.g., a polyimide layer), at least one inorganic layer, and an organic layer (e.g., a polyimide layer).

The circuit element layer DP-CL may include at least one insulating layer and a circuit element. The insulating layer may include at least one inorganic layer and at least one organic layer. The circuit element may include signal lines and a pixel circuit.

The display element layer DP-ED may include at least one light emitting element. The display element layer DP-ED may further include an organic layer such as a pixel defining layer.

The encapsulation substrate ES may be spaced apart from the display element layer DP-ED by a gap GP. The base layer BL and the encapsulation substrate ES may include a plastic substrate, a glass substrate, a metal substrate, or an organic/inorganic composite substrate. The sealant SM may include an organic adhesive or a frit. The gap GP may be filled with a material. The gap GP may be filled with a moisture absorbent or a resin material.

As illustrated in FIG. 3B, the display panel DP may include the base layer BL, the circuit element layer DP-CL disposed on the base layer BL, the display element layer DP-ED, and an upper protective layer TFL. The upper protective layer TFL may include multiple thin films. The upper protective layer TFL may include a capping layer for protecting the light emitting element. The upper protective layer TFL may further include a thin film encapsulation layer that includes at least an inorganic layer, an organic layer, and an inorganic layer. The thin film encapsulation layer may be disposed on the capping layer.

FIG. 4 is an enlarged schematic cross-sectional view of the display module according to an embodiment of the disclosure. FIG. 4 is illustrated based on the display module of FIG. 3B.

Referring to FIG. 4, the display module DM may include the display panel DP and the input sensor ISP directly disposed on the display panel DP. The display panel DP may include the base layer BL, the circuit element layer DP-CL, the display element layer DP-ED, and the upper protective layer TFL. The input sensor ISP may be directly disposed on the upper protective layer TFL.

The display panel DP may include the display area DA (refer to FIG. 5A) and the non-display area NDA (refer to FIG. 5A). In FIG. 4, an enlarged view of a partial region of the display area DA is schematically illustrated.

The base layer BL may provide a base surface on which the circuit element layer DP-CL is disposed. The circuit element layer DP-CL may be disposed on the base layer BL. The circuit element layer DP-CL may include an insulating layer, a semiconductor pattern, a conductive pattern, and a signal line. An insulating layer, a semiconductor layer, and a conductive layer may be formed on the base layer BL by a process such as coating or deposition and may be selectively subjected to patterning by performing a photolithography process multiple times. Thereafter, the semiconductor pattern, the conductive pattern, and the signal line included in the circuit element layer DP-CL may be formed.

At least one inorganic layer may be formed on the upper surface of the base layer BL. FIG. 4 illustrates that the display panel DP includes a buffer layer BFL according to an embodiment. The buffer layer BFL may improve the coupling force between the base layer BL and a semiconductor pattern. The buffer layer BFL may include silicon oxide layers and silicon nitride layers, and the silicon oxide layers and the silicon nitride layers may be alternately stacked each other.

The semiconductor pattern may be disposed on the buffer layer BFL. The semiconductor pattern may include poly-silicon. However, the disclosure is not limited thereto, and in another embodiment, the semiconductor pattern may include amorphous silicon or a metal oxide.

FIG. 4 schematically illustrates only a portion of the semiconductor pattern, and the semiconductor pattern may be additionally disposed in other areas. The semiconductor pattern may be arranged across pixels according to a specific rule. The semiconductor pattern may have an electrical property depending on whether doping is performed or not. The semiconductor pattern may include first areas having a high conductivity and a second area having a low conductivity. The first areas may be doped with an N-type dopant or a P-type dopant. A P-type transistor may include a doped area doped with a P-type dopant. The second area may be an undoped area or may be an area more lightly doped than the first areas.

The first areas may have a higher conductivity than the second area and substantially serve as electrodes or signal lines. The second area may substantially correspond to an active area (or, a channel area) of a transistor TR-P. In other words, a portion of the semiconductor pattern may be the active area of the transistor, and another portion may be a source area or a drain area of the transistor.

Each of the pixels may have a circuit including seven transistors, a capacitor, and a light emitting element, and a circuit of the pixel may be modified in various forms. In FIG. 4, one pixel transistor TR-P and a light emitting element ED that are included in the pixel are illustrated.

A source area SR, a channel area CHR, and a drain area DR of the transistor TR-P may be formed from the semiconductor pattern. The source area SR and the drain area DR may extend from the channel area CHR in opposite directions. In FIG. 4, a portion of a signal transmission area SCL formed to be the first area of the semiconductor pattern is illustrated. Although not separately illustrated, the signal transmission area SCL may be electrically connected with the transistor TR-P in a plan view.

A first insulating layer IL1 may be disposed on the buffer layer BFL. The first insulating layer IL1 may commonly overlap multiple pixels in a plan view and may cover the semiconductor pattern. The first insulating layer IL1 may be an inorganic layer and/or an organic layer and may have a single-layer structure or a multi-layer structure. The first insulating layer IL1 may include at least one of aluminum oxide, titanium oxide, silicon oxide, silicon nitride, silicon oxy nitride, zirconium oxide, and hafnium oxide. In an embodiment, the first insulating layer IL1 may be a single silicon oxide layer. Not only the first insulating layer IL1 but also insulating layers of the circuit element layer DP-CL, which will be described below, may be inorganic layers and/or organic layers and may have a single-layer structure or a multi-layer structure. The inorganic layers may include at least one of the aforementioned materials, but the disclosure is not limited thereto.

A gate GE of the transistor TR-P may be disposed on the first insulating layer IL1. The gate GE may be a portion of a metal pattern. The gate GE may overlap the channel area CHR in a plan view. The gate GE may function as a mask in a process of doping the semiconductor pattern.

A second insulating layer IL2 may be disposed on the first insulating layer IL1 and may cover the gate GE. The second insulating layer IL2 may commonly overlap the pixels in a plan view. The second insulating layer IL2 may be an inorganic layer and/or an organic layer and may have a single-layer structure or a multi-layer structure. In an embodiment, the second insulating layer IL2 may be a single silicon oxide layer.

A third insulating layer IL3 may be disposed on the second insulating layer IL2. In an embodiment, the third insulating layer IL3 may be a single silicon oxide layer. A first connecting electrode CNE1 may be disposed on the third insulating layer IL3. The first connecting electrode CNE1 may be connected to the signal transmission area SCL through a contact hole CNT1 that penetrates the first insulating layer IL1, the second insulating layer IL2, and the third insulating layer IL3.

A fourth insulating layer IL4 may be disposed on the third insulating layer IL3. The fourth insulating layer IL4 may be a single silicon oxide layer. A fifth insulating layer IL5 may be disposed on the fourth insulating layer IL4. The fifth insulating layer IL5 may be an organic layer. In another embodiment, the fourth insulating layer IL4 may be omitted, and the fifth insulating layer IL5 may be disposed on the third insulating layer IL3.

A second connecting electrode CNE2 may be disposed on the fifth insulating layer IL5. The second connecting electrode CNE2 may be connected to the first connecting electrode CNE1 through a contact hole CNT2 that penetrates the fourth insulating layer IL4 and the fifth insulating layer IL5.

A sixth insulating layer IL6 may be disposed on the fifth insulating layer IL5 and may cover the second connecting electrode CNE2. The sixth insulating layer IL6 may be an organic layer. The display element layer DP-ED may be disposed on the circuit element layer DP-CL. The display element layer DP-ED may include the light emitting element ED. The light emitting element ED may include an anode electrode AE, an emissive layer EL, and a cathode electrode CE. For example, the emissive layer EL may include an organic luminescent material, a quantum dot, a quantum rod, a micro-LED, or a nano-LED.

The anode electrode AE may be disposed on the sixth insulating layer IL6. The anode electrode AE may be connected to the second connecting electrode CNE2 through a contact hole CNT3 penetrating the sixth insulating layer IL6.

A pixel defining layer IL7 may be disposed on the sixth insulating layer IL6 and may cover a portion of the anode electrode AE. The pixel defining layer IL7 may have an opening OP7. The opening OP7 of the pixel defining layer IL7 may expose at least a portion of the anode electrodes AE. In an embodiment, an emissive area PXA may be defined to correspond to a partial region of the anode electrode AE exposed by the opening OP7. A non-emissive area NPXA may surround the emissive area PXA in a plan view.

The emissive layer EL may be disposed on the anode electrode AE. The emissive layer EL may be disposed to correspond to the opening OP7. For example, the emissive layer EL may be separately formed in each of the pixels. In case that the emissive layer EL is separately formed in each of the pixels, the emissive layers EL may each emit at least one of blue light, red light, and green light. However, the disclosure is not limited thereto, and in another embodiment, the emissive layer EL may be connected to the pixels and may be provided in common, and the emissive layer EL may provide blue light or white light.

The cathode electrode CE may be disposed on the emissive layer EL. The cathode electrode CE may have a one-body shape and may be commonly disposed in the pixels. A common voltage may be provided to the cathode electrode CE, and the cathode electrode CE may be referred to as a common electrode.

Although not illustrated, a hole control layer may be disposed between the anode electrode AE and the emissive layer EL. The hole control layer may be commonly disposed in the emissive area PXA and the non-emissive area NPXA. The hole control layer may include a hole transport layer or may further include a hole injection layer. Although not illustrated, an electron control layer may be disposed between the emissive layer EL and the cathode electrode CE. The electron control layer may include an electron transport layer or may further include an electron injection layer. The hole control layer and the electron control layer may be commonly formed in the pixels using an open mask.

The upper protective layer TFL may be disposed on the display element layer DP-ED. The upper protective layer TFL may include an inorganic layer, an organic layer, and an inorganic layer sequentially stacked each other. However, layers constituting the upper protective layer TFL are not limited thereto. The inorganic layers may protect the display element layer DP-ED from moisture and oxygen, and the organic layer may protect the display element layer DP-ED from foreign matter such as dust particles.

The input sensor ISP may be directly formed on the upper surface of the upper protective layer TFL through a continuous process. The input sensor ISP may include a first intermediate insulating layer IIL1, a first sensing conductive layer ICL1, a second intermediate insulating layer IIL2, a second sensing conductive layer ICL2, and a third intermediate insulating layer IIL3. In this specification, the first intermediate insulating layer IIL1 may be referred to as a “base insulating layer”.

Each of the first sensing conductive layer ICL1 and the second sensing conductive layer ICL2 may have a single-layer structure or may include multiple patterns having a multi-layer structure stacked in the third direction DR3. A conductive layer having a single-layer structure may include a metal layer or a transparent conductive layer. A metal layer of the first sensing conductive layer ICL1 and the second sensing conductive layer ICL2 may include molybdenum, silver, titanium, copper, aluminum, or an alloy thereof. A transparent conductive layer of the first sensing conductive layer ICL1 and the second sensing conductive layer ICL2 may include a transparent conductive oxide such as indium tin oxide (ITO), indium zinc oxide (IZO), zinc oxide (ZnO), or indium zinc tin oxide (IZTO). In another embodiment, a transparent conductive layer of the first sensing conductive layer ICL1 and the second sensing conductive layer ICL2 may include a conductive polymer such as PEDOT, a metal nano-wire, or graphene.

A conductive layer having a multi-layer structure may include metal layers. Metal layers of the first sensing conductive layer ICL1 and the second sensing conductive layer ICL2 may have, for example, a three-layer structure of titanium/aluminum/titanium. In an embodiment, the first sensing conductive layer ICL1 and the second sensing conductive layer ICL2 having the multi-layer structure may include at least one metal layer and at least one transparent conductive layer.

The second intermediate insulating layer IIL2 may cover the first sensing conductive layer ICL1, and the third intermediate insulating layer IIL3 may cover the second sensing conductive layer ICL2. Although each of the first to third intermediate insulating layers IIL1, IIL2, and IIL3 is illustrated as a single layer, the disclosure is not limited thereto.

At least one of the first intermediate insulating layer IIL1 and the second intermediate insulating layer IIL2 may include an inorganic film. An inorganic film of at least one of the first intermediate insulating layer IIL1 and the second intermediate insulating layer IIL2 may include at least one of aluminum oxide, titanium oxide, silicon oxide, silicon nitride, silicon oxy nitride, zirconium oxide, and hafnium oxide.

At least one of the second intermediate insulating layer IIL2 and the third intermediate insulating layer IIL3 may include an organic film. An organic film of at least one of the second intermediate insulating layer IIL2 and the third intermediate insulating layer IIL3 may include at least one of an acrylic resin, a methacrylic resin, a polyisoprene resin, a vinyl resin, an epoxy resin, a urethane-based resin, a cellulosic resin, a siloxane-based resin, a polyimide resin, a polyamide resin, and a perylene-based resin.

FIG. 5A is a plan view illustrating the display panel and a drive circuit according to an embodiment of the disclosure.

Referring to FIG. 5A, the display panel DP may include the display area DA that displays an image and the non-display area NDA adjacent to the periphery of the display area DA. The display area DA may be an area corresponding to the active area AA illustrated in FIG. 1, and the non-display area NDA may be an area corresponding to the peripheral area NAA illustrated in FIG. 1. The display area DA may be an area where an image is substantially displayed, and the non-display area NDA may be a bezel area where an image is not displayed. Although FIG. 5 illustrates the structure in which the non-display area NDA is disposed to surround the display area DA, the disclosure is not limited thereto, and in another embodiment the non-display area NDA may be disposed only on at least one side of the display area DA.

Multiple gate lines GL, multiple emission control lines EL, multiple data lines DL, and multiple pixels PX may be disposed in the display area DA. In an embodiment of the disclosure, one gate line, one emission control line, and one data line may be connected to one of the pixels PX. However, the disclosure is not limited thereto, and one or more gate lines or one or more emission control lines may be connected to a pixel PX.

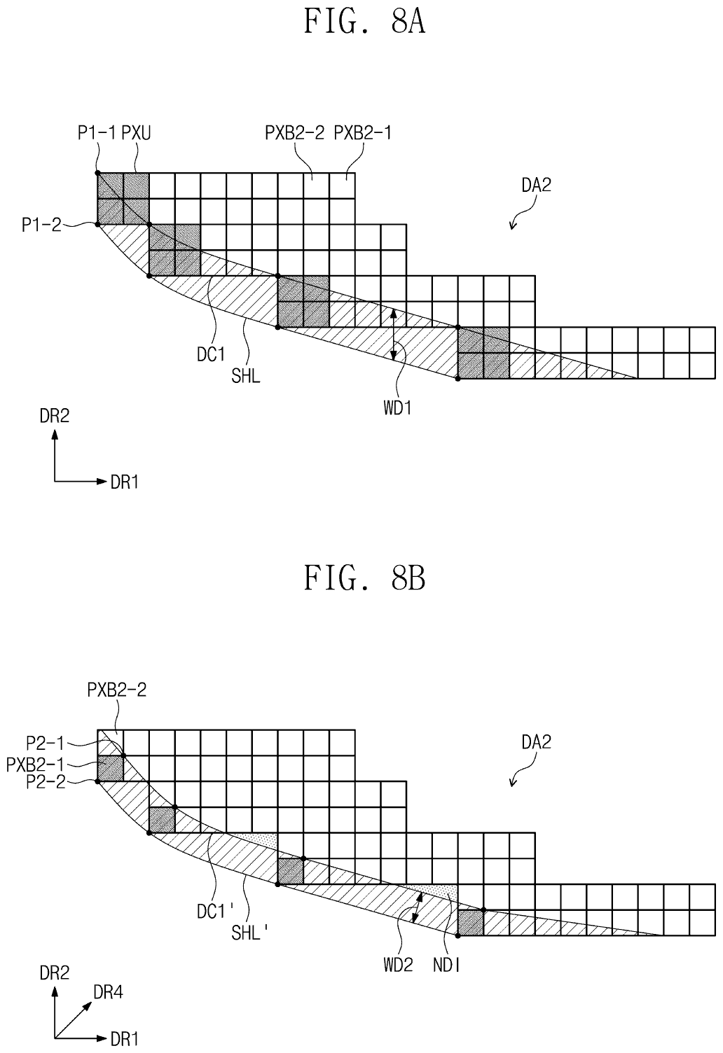

The display area DA may include corners DC1, DC2, DC3, and DC4 (hereinafter, referred to as the first to fourth corners). Each of the first to fourth corners DC1 to DC4 may have a step shape. However, the disclosure is not limited thereto. In another embodiment, only some of the first to fourth corners DC1 to DC4 may have a multi-step shape, and the rest may have a single angled shape. Since the first to fourth corners DC1 to DC4 have a step shape, the pixels PX disposed adjacent to the first to fourth corners DC1 to DC4 may be arranged in a multi-step shape (refer to FIGS. 8A and 8B).

The drive circuit PDC may include a gate drive circuit GDC, an emission drive circuit EDC, and a data drive circuit DDC. The gate drive circuit GDC may be connected with the gate lines DL, the emission drive circuit EDC may be connected with the emission control lines EL, and the data drive circuit DDC may be connected with the data lines DL. The gate drive circuit GDC may provide a gate signal to the gate lines GL, the emission drive circuit EDC may provide an emission control signal to the emission control lines EL, and the data drive circuit DDC may output a data signal to the data lines DL. Each of the pixels PX may express a gray scale corresponding to the data signal in response to the gate signal and the emission control signal.

The gate drive circuit GDC and the emission drive circuit EDC may be embedded in the display panel DP. The expression “embedded in the display panel DP” used herein may mean that the gate drive circuit GDC and the emission drive circuit EDC are directly formed in the display panel DP through a thin film process of forming the pixels PX in the display panel DP. The data drive circuit DDC may be manufactured in the form of a chip and may be mounted on the non-display area NDA of the display panel DP.

The display area DA may include a first display area DA1 and a second display area DA2. The second display area DA2 may include an area that overlaps the gate drive circuit GDC and/or the emission drive circuit EDC in a plan view. The second display area DA may include a second-first display area DA2-1 overlapping the gate drive circuit GDC and a second-second display area DA2-2 overlapping the emission drive circuit EDC in a plan view. The first display area DA1 may be an area of the display area DA other than the second display area DA2. The first display area DA1 may be an area that does not overlap the gate drive circuit GDC and/or the emission drive circuit EDC in a plan view.

Among the pixels PX, pixels disposed in the first display area DA1 may be referred to as first pixels PX1, and pixels disposed in the second display area DA2 may be referred to as second pixels PX2. Each of the first pixels PX1 may include a first pixel circuit and a first light emitting element connected with the first pixel circuit, and each of the second pixels PX2 may include a second pixel circuit and a second light emitting element connected with the second pixel circuit. In an embodiment of the disclosure, the second light emitting elements of some of the second pixels PX2 may overlap the gate drive circuit GDC or the emission drive circuit EDC in a plan view.

The first pixels PX1 and the second pixels PX2 adjacent to the first to fourth corners DC1 to DC4 may be arranged in a multi-step shape. Accordingly, the first to fourth corners DC1 to DC4 that define the boundary between the display area DA and the non-display area NDA may have a step shape.

FIG. 5B is an enlarged view of area AA in FIG. 5A. Although the first corner DC1 is illustrated in FIG. 5B, the second to fourth corners DC2 to DC4 (refer to FIG. 5A) may also have a structure similar to the first corner DC1.

Referring to FIG. 5B, since the first pixels PX1 and the second pixels PX2 adjacent to the first corner DC1 are arranged in a multi-step shape, the first corner DC1 may have a step shape.

The first pixels PX1 may include a first-first pixel PX1-1 that emits light of a first color (e.g., red light), a first-second pixel PX1-2 that emits light of a second color (e.g., green light), and a first-third pixel PX1-3 that emits light of a third color (e.g., blue light). The first pixels PX1 may constitute a first-first pixel cell PXB1-1 or a first-second pixel cell PXB1-2. The first-first pixel cell PXB1-1 may include one first-first pixel PX1-1 and one first-second pixel PX1-2, and the first-second pixel cell PXB1-2 may include one first-second pixel PX1-2 and one first-third pixel PX1-3. The first-first pixel cell PXB1-1 and the first-second pixel cell PXB1-2 may be alternately arranged in the first direction DR1 and the second direction DR2.

The second pixels PX2 may include a second-first pixel PX2-1 that emits light of the first color, a second-second pixel PX2-2 that emits light of the second color, and a second-third pixel PX2-3 that emits light of the third color. The second pixels PX2 may constitute a second-first pixel cell PXB2-1 or a second-second pixel cell PXB2-2. The second-first pixel cell PXB2-1 may include one second-first pixel PX2-1 and one second-second pixel PX2-2, and the second-second pixel cell PXB2-2 may include one second-second pixel PX2-2 and one second-third pixel PX2-3. The second-first pixel cell PXB2-1 and the second-second pixel cell PXB2-2 may be alternately arranged in the first direction DR1 and the second direction DR2.

In an embodiment of the disclosure, the areas of emissive areas of the first pixels PX1 may be equal to the areas of emissive areas of the second pixels PX2 in a plan view. For example, the area of an emissive area of the first-first pixel PX1-1 may be equal to the area of an emissive area of the second-first pixel PX2-1, the area of an emissive area of the first-second pixel PX1-2 may be equal to the area of an emissive area of the second-second pixel PX2-2, and the area of an emissive area of the first-third pixel PX1-3 may be equal to the area of an emissive area of the second-third pixel PX2-3 in a plan view. However, the disclosure is not limited thereto. For example, the areas of the emissive areas of the first pixels PX1 and the areas of the emissive areas of the second pixels PX2 may be different from each other in a plan view.

The second-first pixel cell PXB2-1 and the second-second pixel cell PXB2-2 may be arranged in a multi-step shape at the first corner DC1. In an embodiment of the disclosure, as the second-first pixel cell PBX2-1 and the second-second pixel cell PBX2-2 are arranged in a multi-step shape, the first-first pixel cell PBX1-1 and the first-second pixel cell PBX1-2 may also be arranged in a multi-step shape.

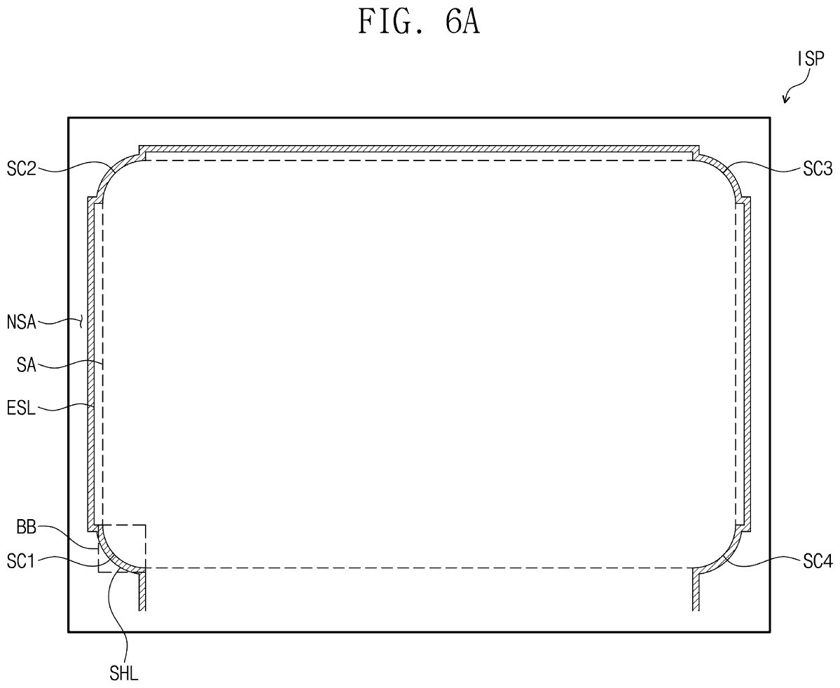

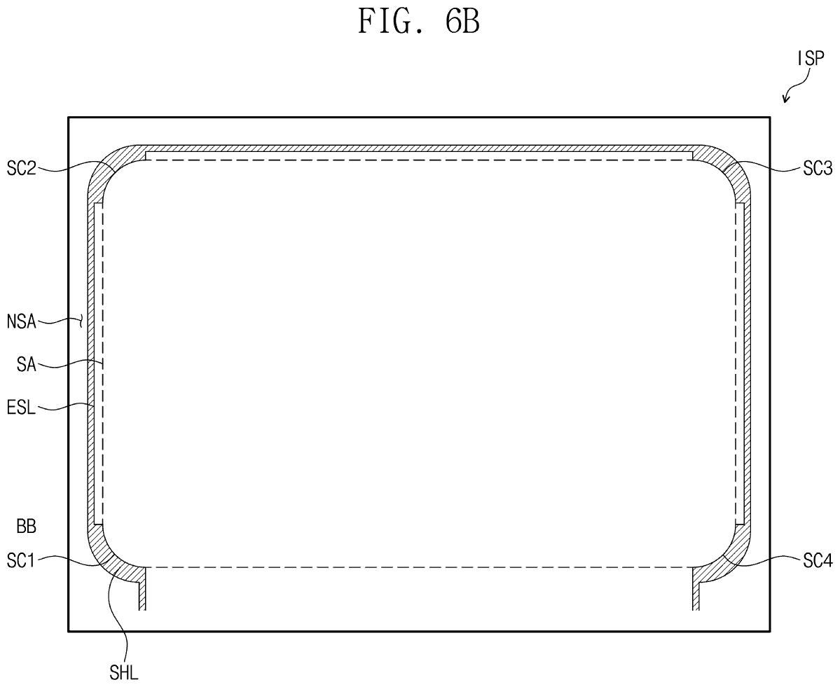

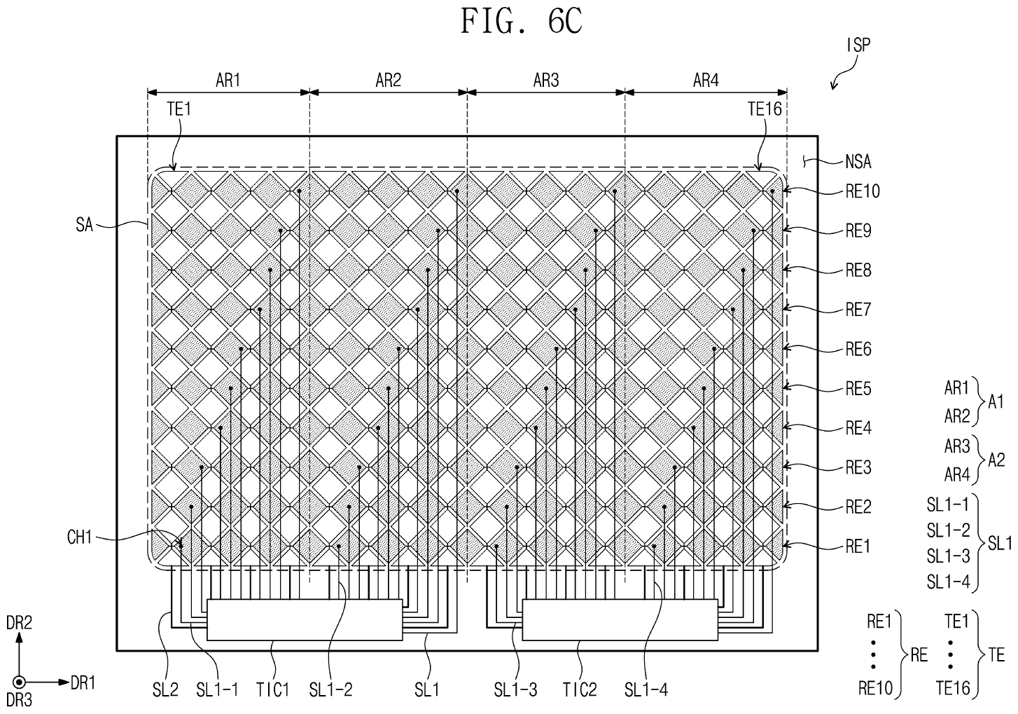

FIG. 6A is a plan view of the input sensor according to an embodiment of the disclosure. FIG. 6B is a plan view of the input sensor according to an embodiment of the disclosure.

Referring to FIGS. 6A and 6B, the input sensor ISP may include a sensing area SA and a non-sensing area NSA adjacent to the sensing area SA. The sensing area SA and the non-sensing area NSA may be areas that correspond to the display area DA and the non-display area NDA of the display panel DP illustrated in FIG. 5A. The sensing area SA may include corners SC1, SC2, SC3, and SC4 (hereinafter, referred to as the fifth to eighth corners). Each of the fifth to eighth corners SC1 to SC4 may have a round shape in a plan view.

The input sensor ISP may include an antistatic line ESL disposed in the non-sensing area NSA and surrounding the sensing area SA in a plan view. The antistatic line ESL may be grounded and may block the introduction of static electricity into the sensing area SA.

The input sensor ISP may further include a shielding line SHL. The shielding line SHL may be disposed in the non-sensing area NSA adjacent to the fifth to eighth corners SC1 to SC4 of the sensing area SA. The shielding line SHL may have a round shape to correspond to the shape of the fifth to eighth corners SC1 to SC4 in a plan view.

At the fifth to eighth corners SC1 to SC4, the shielding line SHL may be disposed directly adjacent to the sensing area SA, whereas the antistatic line ESL may be spaced apart from the sensing area SA. In an embodiment of the disclosure, the shielding line SHL may be curved from the antistatic line ESL toward the sensing area SA. The shielding line SHL and the antistatic line ESL may have a one-body shape. For example, the shielding line SHL may be a portion of the antistatic line ESL.

As illustrated in FIG. 6B, the antistatic line ESL may protrude toward the sensing area SA at the fifth to eighth corners SC1 to SC4 to form the shielding line SHL. For example, the width of the antistatic line ESL in a plan view may be increased at the fifth to eighth corners SC1 to SC4 to provide the shielding line SHL.

FIG. 6C is a plan view of the input sensor according to an embodiment of the disclosure. Although the antistatic line ESL and the shielding line SHL are not illustrated in FIG. 6C for convenience of description, the input sensor ISP illustrated in FIG. 6C may employ the antistatic line ESL and the shielding line SHL illustrated in FIG. 6A or 6B.

Referring to FIG. 6C, the input sensor ISP may include first sensing electrodes RE and second sensing electrodes TE. The first sensing electrodes RE and second sensing electrodes TE may be electrically insulated from each other and may cross each other.

Each of the first sensing electrodes RE may extend in the first direction DR1. The first sensing electrodes RE may be spaced apart from one another in the second direction DR2. For example, the first sensing electrodes RE may include first to tenth row sensing electrodes RE1 to RE10. Although FIG. 6C illustrates an embodiment that the number of first sensing electrodes RE is ten, the number of first sensing electrodes RE is not limited thereto.

Each of the second sensing electrodes TE may extend in the second direction DR2. The second sensing electrodes TE may be spaced apart from one another in the first direction DR1. For example, the second sensing electrodes TE may include first to sixteenth column sensing electrodes TE1 to TE16. Although FIG. 6C illustrates an embodiment that the number of second sensing electrodes TE is sixteen, the number of second sensing electrodes TE is not limited thereto.

In an embodiment, the first sensing electrodes RE may be longer than the second sensing electrodes TE, and the number of first sensing electrodes RE may be smaller than the number of second sensing electrodes TE. However, the disclosure is not limited thereto.

The input sensor ISP may obtain information about the input TC (refer to FIG. 1) through a change in the mutual capacitance between the first sensing electrodes RE and the second sensing electrodes TE.

The input sensor ISP may include first trace lines SL1 electrically connected to the first sensing electrodes RE and second trace lines SL2 electrically connected to the second sensing electrodes TE. At least one of the first trace lines SL1 may overlap the sensing area SA in a plan view. The second trace lines SL2 may not overlap the sensing area SA and may overlap the non-sensing area NSA in a plan view. In another embodiment, the first trace lines SL1 may not overlap the sensing area SA and may overlap the non-sensing area NSA in a plan view.

The first sensing electrodes RE may be electrically connected to sensing controllers TIC1 and TIC2 through the first trace lines SL1, and the second sensing electrodes TE may be electrically connected to the sensing controllers TIC1 and TIC2 through the second trace lines SL2. The second sensing electrodes TE may receive a transmission signal from the sensing controllers TIC1 and TIC2 through the second trace lines SL2. A change in the mutual capacitance between the second sensing electrodes TE and the first sensing electrodes RE may occur at the position where the input TC is provided. The sensing controllers TIC1 and TIC2 may generate the coordinate values of the position where the input TC is provided, based on a reception signal received from the first trace lines SL1.

In an embodiment, each of the first sensing electrodes RE and the second sensing electrodes TE illustrated in FIG. 6C may include multiple mesh lines intersecting one another and may have a mesh shape in which multiple touch openings are defined in a plan view.

In an embodiment of the disclosure, the sensing area SA may include multiple sensing areas sequentially arranged in the first direction DR1. Although four sensing areas (for example, first to fourth sensing areas AR1, AR2, AR3, and AR4) are illustrated in FIG. 6C, the number of sensing areas is not limited thereto. The first sensing area AR1 and the second sensing area AR2 may be located in a first area A1, and the third sensing area AR3 and the fourth sensing area AR4 may be located in a second area A2.

The first trace lines SL1 may include first-first trace lines SL1-1, first-second trace lines SL1-2, first-third trace lines SL1-3, and first-fourth trace lines SL1-4 that are disposed in the first to fourth sensing areas AR1, AR2, AR3, and AR4, respectively.

Each of the first to tenth row sensing electrodes RE1 to RE10 may be connected with two or more first trace lines SL1. In an embodiment of the disclosure, each of the first to tenth row sensing electrodes RE1 to RE10 may be connected with four first trace lines SL1. For example, the first row sensing electrode RE1 may be connected to a corresponding first-first trace line SL1-1 through a contact hole CH1 in the first sensing area AR1 and connected to a corresponding first-second trace line SL1-2 through a contact hole CH1 in the second sensing area AR2. The first row sensing electrode RE1 may be connected to a corresponding first-third trace line SL1-3 through a contact hole CH1 in the third sensing area AR3 and connected to a corresponding first-fourth trace line SL1-4 through a contact hole CH1 in the fourth sensing area AR4.

In FIG. 6C, the first-first trace lines SL1-1, the first-second trace lines SL1-2, the first-third trace lines SL1-3, and the first-fourth trace lines SL1-4 are all illustrated as being disposed to overlap the sensing area SA in a plan view. However, the disclosure is not limited thereto. In another embodiment, at least one of the first-first trace lines SL1-1, the first-second trace lines SL1-2, the first-third trace lines SL1-3, and the first-fourth trace lines SL1-4 may be disposed to overlap the non-sensing area NSA in a plan view.

The first-first trace lines SL1-1, the first-second trace lines SL1-2, the first-third trace lines SL1-3, and the first-fourth trace lines SL1-4 may be connected to the sensing controllers TIC1 and TIC2 in the non-sensing area NSA. In an embodiment of the disclosure, the first-first trace lines SL1-1 and the first-second trace lines SL1-2 may be connected to the first sensing controller TIC1, and the first-third trace lines SL1-3 and the first-fourth trace lines SL1-4 may be connected to the second sensing controller TIC2.

The connection structure of the first row sensing electrode RE1 and the corresponding first-first to first-fourth trace lines SL1-1 to SL1-4 may be identically applied to the second to tenth row sensing electrodes RE2 to RE10.

The first sensing electrodes RE and the second sensing electrodes TE may be formed to correspond to the shape of the sensing area SA. The first sensing electrodes RE and the second sensing electrodes TE adjacent to the fifth to eighth corners SC1 to SC4 of the sensing area SA may have a round shape in a plan view to correspond to the shape of the fifth to eighth corners SC1 to SC4.

The antistatic line ESL illustrated in FIGS. 6A and 6B may be electrically connected with the sensing controllers TIC1 and TIC2.

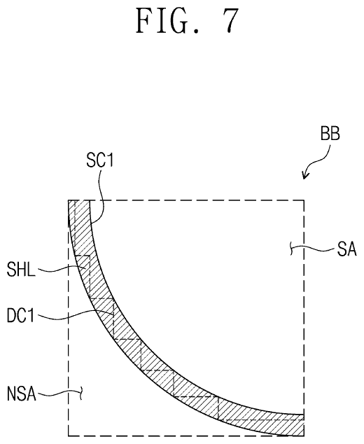

FIG. 7 is an enlarged view illustrating area BB of the input sensor in FIG. 6A.

Referring to FIG. 7, the input sensor ISP (refer to FIG. 6A) may include the sensing area SA and the non-sensing area NSA.

The fifth corner SC1 may be defined on the input sensor ISP by the shielding line SHL. The area inside the fifth corner SC1 may be the sensing area SA, and the area outside the fifth corner SC1 may be the non-sensing area NSA. Since the shielding line SHL has a round shape, the first corner DC1 may be shielded by the shielding line SHL even though the first corner DC1 of the display panel DP (refer to FIG. 5A) has a step shape, and thus the step pattern may be prevented from being visible.

For example, some the second pixels PX2 (refer to FIG. 5B) disposed in a multi-step shape at the first corner DC1 may be shielded by the shielding line SHL. Light output from the second pixels PX2 overlapping the shielding line SHL in a plan view may be blocked by the shielding line SHL and not output to the outside, and only light output from the second pixels PX2 that do not overlap the shielding line SHL in a plan view may be output to the outside. Accordingly, even though the second pixels PX2 are disposed in a multi-step shape at the first corner DC1, the multi-step pattern may not be visible, and thus a phenomenon in which display quality is deteriorated at the first to fourth corners DC1 to DC4 may be prevented.

FIG. 8A is a schematic diagram illustrating an arrangement of the second pixels in the second display area according to an embodiment of the disclosure. FIG. 8B is a schematic diagram illustrating an arrangement of the second pixels in the second display area according to an embodiment of the disclosure.

Referring to FIGS. 8A and 8B, the second-first pixel cell PBX2-1 and the second-second pixel cell PBX2-2 may be alternately arranged in the second display area DA2 in the first direction DR1 and the second direction DR2.

In an embodiment of the disclosure, a pixel unit PXU may include two second-first pixel cells PBX2-1 and two second-second pixel cells PBX2-2, but the disclosure is not limited thereto. For example, one pixel unit PXU may include two second-first pixels PX2-1 (refer to FIG. 5B), four second-second pixels PX2-2 (refer to FIG. 5B), and two second-third pixels PX2-3 (refer to FIG. 5B).

Referring to FIG. 8A, pixel units PXU may be arranged in a multi-step shape. A side of the shielding line SHL may be disposed along first-first points P1-1 of the pixel units PXU at the outermost positions (hereinafter, referred to as the outermost pixel units), and an opposite side of the shielding line SHL may be disposed along first-second points P1-2 of the outermost pixel units PXU. The first-first points P1-1 may be the upper left corner points of the outermost pixel units PXU, and the first-second points P1-2 may be the lower left corner points of the outermost pixel units PXU. However, the disclosure is not limited thereto, and the shielding line SHL may be formed along various points of the outermost pixel units PXU such that the multi-step shape of the outermost pixel units PXU is not visible and the area by which the outermost pixel units PXU output light while not overlapping the shielding line SHL is maximized. Accordingly, the line connecting the first-first points P1-1 of the outermost pixel units PXU may have a gently curved shape compared to the line connecting the sides of the outermost pixel units PXU. Thus, the shielding line SHL may be formed in a round shape so that display quality may be improved.

The first corner DC1 may be defined by the pixel units PXU disposed in the multi-step shape. For example, the first corner DC1 may be a curve fitted to the first-first points P1-1 of the pixel units PXU. The first corner DC1 may be a boundary between the second display area DA2 (refer to FIG. 5A) and the non-display area NDA (refer to FIG. 5B). The second display area DA2 may be an area located inside the first corner DC1, and the non-display area NDA may be an area located outside the first corner DC1.

The pixel units PXU, in a plan view, may overlap the shielding line SHL having a first blocking width WD1. The area where each of the pixel units PXU overlaps the shielding line SHL may be an area that is shielded by the shielding line SHL and that does not substantially display an image. The first blocking width WD1 may be set corresponding to the size of the pixel unit PXU. In an embodiment of the disclosure, the first blocking width WD1 may correspond to (or, may be equal to) the length of the pixel unit PXU in the second direction DR2.

Referring to FIG. 8B, the second-first pixel cell PBX2-1 and the second-second pixel cell PBX2-2 may be disposed in a multi-step shape. A side of a shielding line SHL′ may be disposed along second-first points P2-1 of the second pixel cells PBX2-1 and PBX2-2 at the outermost positions (hereinafter, referred to as the outermost pixel cells), and an opposite side of the shielding line SHL′ may be connected along second-second points P2-2 of the outermost pixel cells PBX2-1 and PBX2-2. The second-first points P2-1 may be upper right corner points of the outermost pixel cells PBX2-1 and PBX2-2, and the second-second points P2-2 may be lower left corner points of the outermost pixel cells PBX2-1 and PBX2-2. However, the disclosure is not limited thereto, and the shielding line SHL′ may be formed along various points of the outermost pixel cells PBX2-1 and PBX2-2 such that the multi-step shape of the outermost pixel cells PBX2-1 and PBX2-2 is not visible and the area by which the outermost pixel cells PBX2-1 and PBX2-2 output light while not overlapping the shielding line SHL′ is maximized. Accordingly, the line connecting the second-first points P2-1 of the outermost pixel cells PBX2-1 and PBX2-2 may have a gently curved shape compared to the line connecting the sides of the outermost pixel cells PBX2-1 and PBX2-2. Thus, the shielding line SHL′ may be formed in a round shape so that display quality may be improved.

A first corner DC1′ may be defined by the second-first pixel cells PBX2-1 and the second-second pixel cells PBX2-2 disposed in the multi-step shape. For example, the first corner DC1′ may be a curve fitted to the second-first points P2-1 of the outermost pixel cells PBX2-1 and PBX2-2. The first corner DC1′ may be a boundary between the second display area DA2 and the non-display area NDA. The second display area DA2 may be an area located inside the first corner DC1', and the non-display area NDA may be an area located outside the first corner DC1'.

The second pixel cells PBX2-1 and PBX2-2, in a plan view, may overlap the shielding line SHL′ having a second blocking width WD2. The area where each of the second pixel cells PBX2-1 and PBX2-2 overlaps the shielding line SHL′ may be an area that is shielded by the shielding line SHL′ and that does not substantially display an image. The second blocking width WD2 may be set corresponding to the sizes of the second pixel cells PBX2-1 and PBX2-2. In an embodiment of the disclosure, the second blocking width WD2 may correspond to (or, may be equal to) the lengths of the second pixel cells PBX2-1 and PBX2-2 in a fourth direction DR4 intersecting the first direction DR1 and the second direction DR2.

In case that the shielding line SHL′ is disposed along the second-first points P2-1 of the second pixel cells PBX2-1 and PBX2-2, the inner side of the shielding line SHL′ may further include a non-dimming area NDI in addition to the second pixel cells PBX2-1 and PBX2-2. The non-dimming area NDI may be an area where pixels are not disposed and therefore no image is displayed.

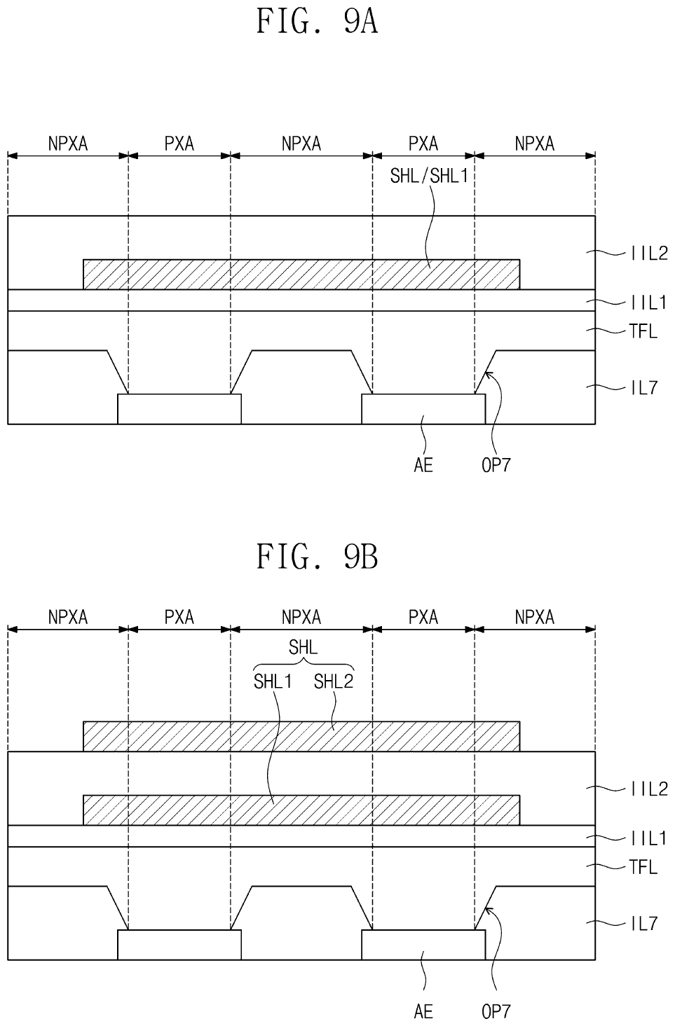

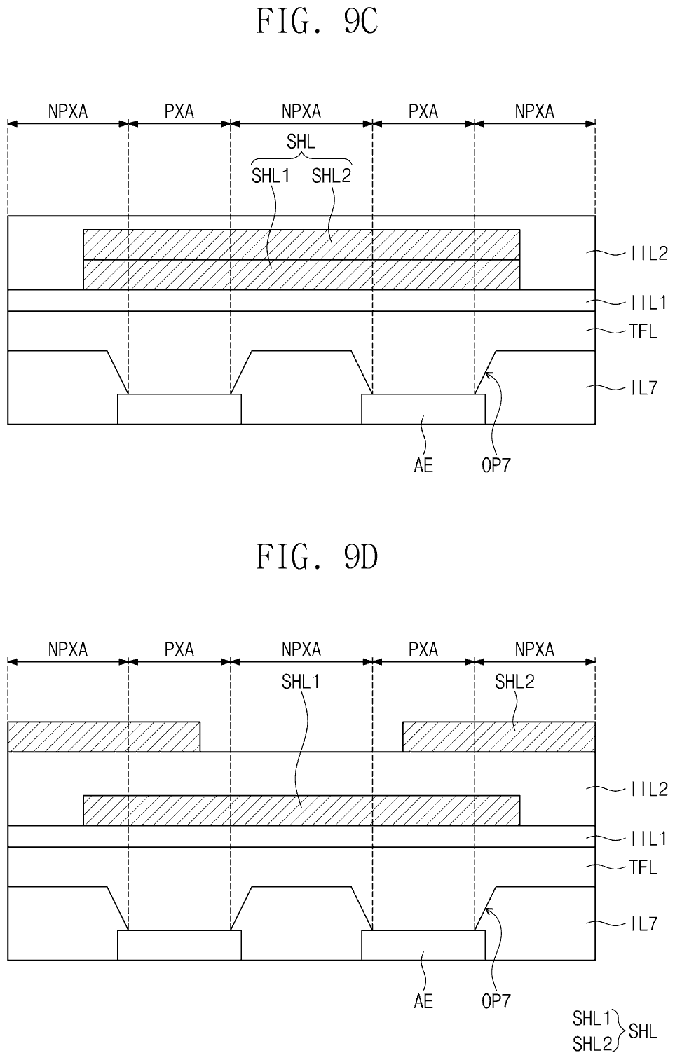

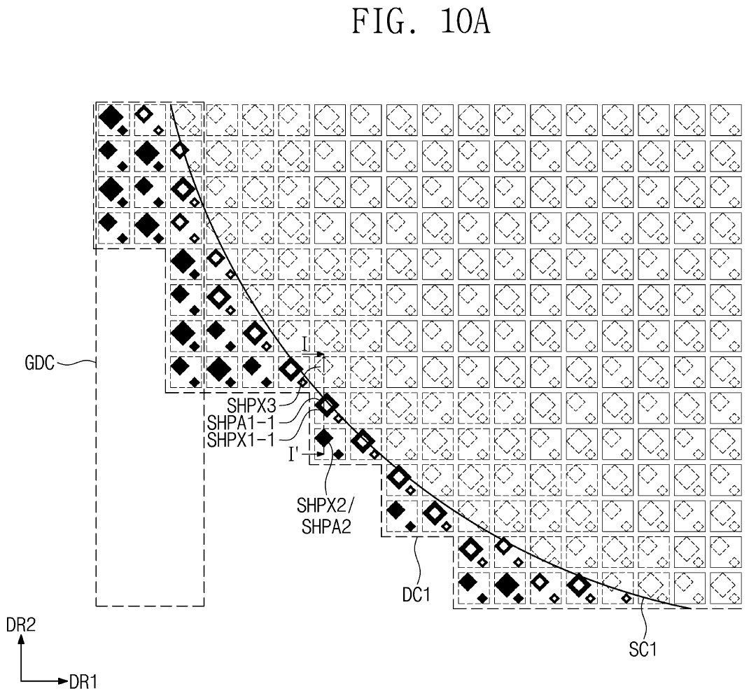

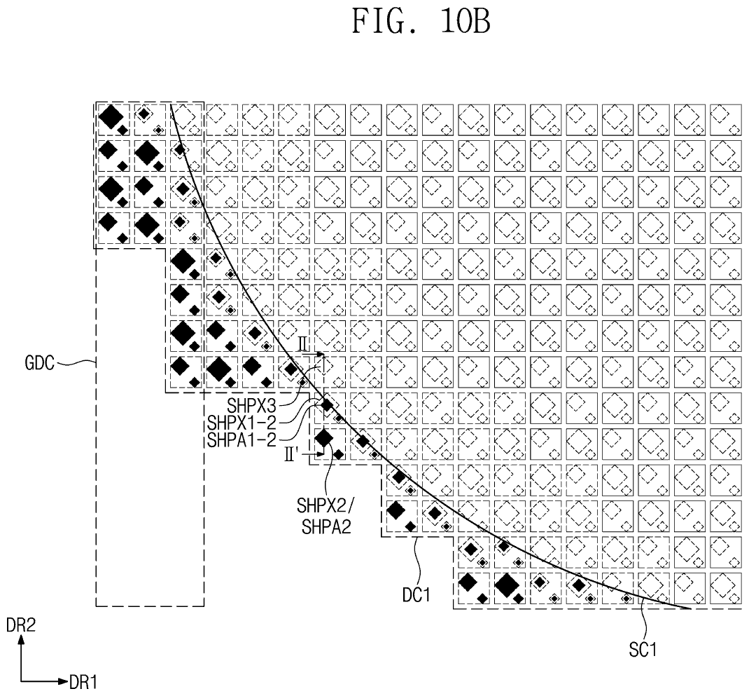

FIGS. 9A to 9D are schematic diagrams illustrating arrangements of shielding lines according to embodiments of the disclosure.

Referring to FIG. 9A, the shielding line SHL may include a first shielding line SHL1, and the first shielding line SHL1 may overlap the anode electrode AE in a plan view. In FIG. 9A, the emissive layer EL (refer to FIG. 4) and the cathode electrode CE (refer to FIG. 4) of the light emitting element ED (refer to FIG. 4) are omitted, and only the anode electrode AE is illustrated.

The pixel defining layer IL7 may cover a portion of the anode electrode AE. The pixel defining layer IL7 may have an opening OP7. The opening OP7 of the pixel defining layer IL7 may expose at least a portion of the second pixel PX2. In an embodiment, the emissive area PXA may be defined to correspond to a partial region of the anode electrode AE exposed by the opening OP7 of the pixel defining layer IL7. The non-emissive area NPXA may surround the emissive area PXA in a plan view.

The upper protective layer TFL may be disposed on the pixel defining layer IL7, and the first intermediate insulating layer IIL1 may be disposed on the upper protective layer TFL. The first shielding line SHL1 may be disposed on the first intermediate insulating layer IIL1. The second intermediate insulating layer IIL2 may be disposed on the first intermediate insulating layer IIL1. The second intermediate insulating layer IIL2 may include an organic film or an inorganic film. The second intermediate insulating layer IIL2 may cover the first shielding line SHL1 disposed on the first intermediate insulating layer IIL1. Although FIG. 9A illustrates the structure in which the first shielding line SHL1 is disposed on the first intermediate insulating layer IIL1 according to an embodiment, the disclosure is not limited thereto. In another embodiment, the first shielding line SHL1 may be disposed on the second intermediate insulating layer IIL2.

In an embodiment of the disclosure, the first shielding line SHL1 may overlap two or more anode electrodes AE in a plan view and may block light output from two or more second pixels PX2 (refer to FIG. 5A).

Referring to FIGS. 9B to 9D, the shielding line SHL may include the first shielding line SHL1 and the second shielding line SHL2, and each of the first shielding line SHL1 and the second shielding line SHL2 may overlap the second pixel PX2 in a plan view. The first shielding line SHL1 and the second shielding line SHL2 may be electrically connected with each other. For example, the shielding line SHL may have a double layer structure by the first shielding line SHL1 and the second shielding line SHL2.

In FIGS. 9B to 9D, the emissive layer EL (refer to FIG. 4) and the cathode electrode CE (refer to FIG. 4) of the light emitting element ED (refer to FIG. 4) are omitted, and only the anode electrode AE is illustrated.

Referring to FIG. 9B, the first shielding line SHL1 may be disposed on the first intermediate insulating layer IIL1, and the second shielding line SHL2 may be disposed on the second intermediate insulating layer IIL2. However, the disclosure is not limited thereto, and in another embodiment illustrated in FIG. 9C, the second shielding line SHL2 may be directly disposed on the first shielding line SHL1.

In an embodiment of the disclosure, the first shielding line SHL1 and the second shielding line SHL2 may overlap each other in a plan view. Each of the first shielding line SHL1 and the second shielding line SHL2 may overlap two or more anode electrodes AE in a plan view. Accordingly, the first shielding line SHL1 and the second shielding line SHL2 may block light output from the second pixel PX2 (refer to FIG. 5A).

In case that the shielding line SHL has the double layer structure as described above, a shielding effect may be further improved.

In an embodiment of the disclosure, the first shielding line SHL1 and the second shielding line SHL2 may partially overlap each other in a plan view, and the width of the first shielding line SHL1 and the second shielding line SHL2 may be increased. Accordingly, the first shielding line SHL1 and the second shielding line SHL2 may be prevented from being visible from the outside, and the shielding effect may be further improved.

In FIGS. 9A to 9D, the anode electrode AE is illustrated as being entirely shielded by the first shielding line SHL1 and/or the second shielding line SHL2. However, in case that the first shielding line SHL1 and/or the second shielding line SHL2 partially overlaps the anode electrode AE in a plan view and an area where the anode electrode AE does not overlap the first shielding line SHL1 in a plan view and/or the second shielding line SHL2 exists, the second pixel PX2 (refer to FIG. 5A) may partially emit light by the non-overlapping area.

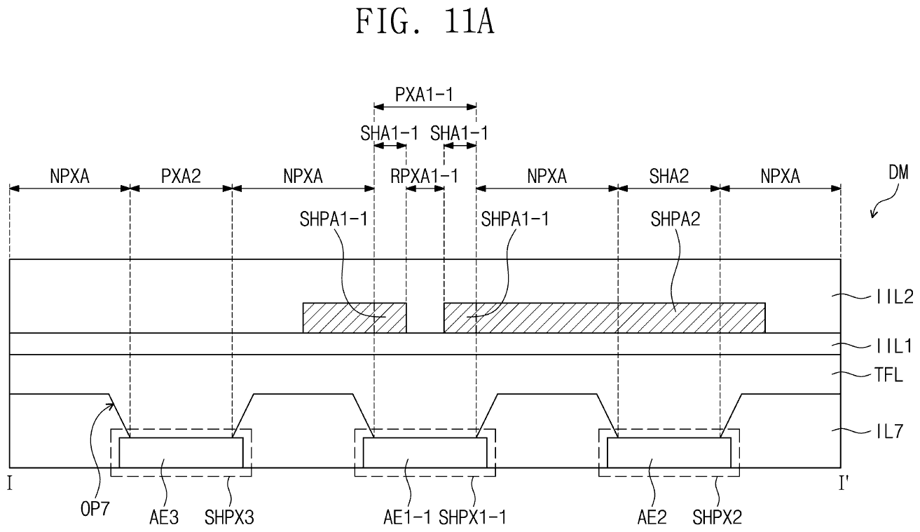

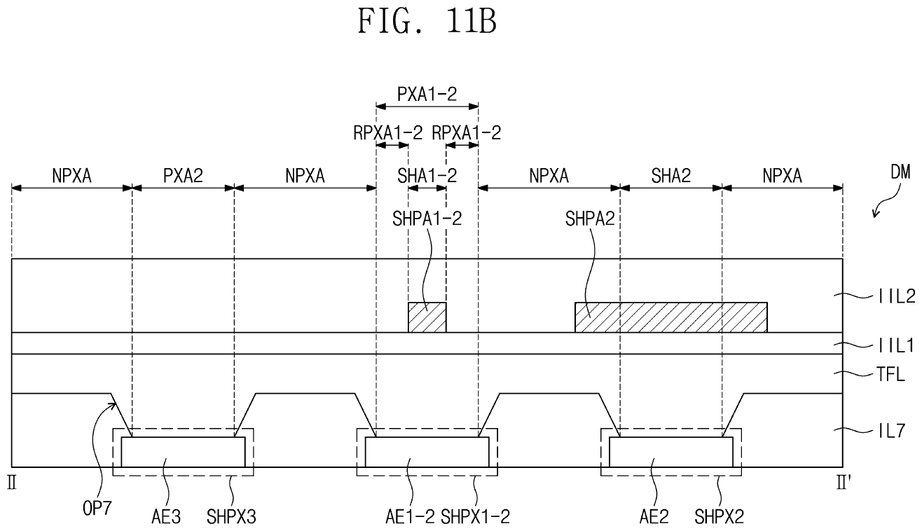

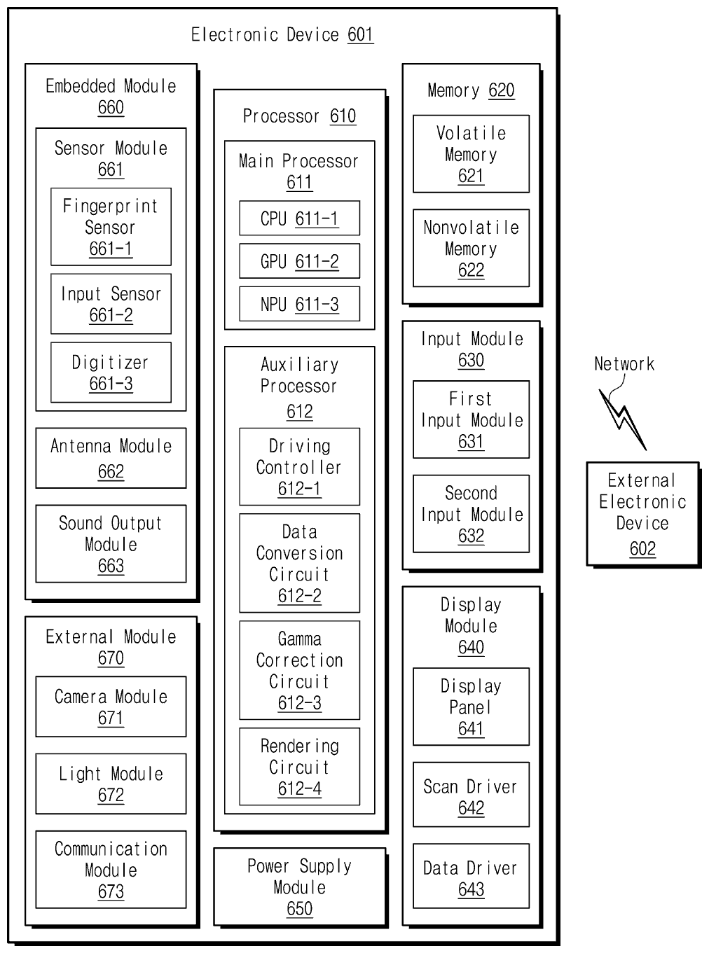

FIG. 10A is a schematic diagram of the second pixels according to an embodiment of the disclosure. FIG. 10B is a schematic diagram of the second pixels according to an embodiment of the disclosure. FIG. 11A is a schematic cross-sectional view of the display module taken along line I-I′ of FIG. 10A. FIG. 11B is a schematic cross-sectional view of the display module taken along line II-II′ of FIG. 10B.

Referring to FIGS. 10A and 11A, the input sensor ISP (refer to FIG. 6A) may include a first-first shielding pattern SHPA1-1 and a second shielding pattern SHPA2.

The second pixels PX2 (refer to FIG. 5B) may include a first-first shielded pixel SHPX1-1, a second shielded pixel SHPX2, and a non-shielded pixel SHPX3. In FIG. 10A, the first pixels PX1 and the second pixels PX2 on the display panel DP (refer to FIG. 5A) are illustrated by dotted lines, and the first-first shielding pattern SHPA1-1 and the second shielding pattern SHPA2 included in the input sensor ISP (refer to FIG. 6A) on the display panel DP are illustrated.

The input sensor ISP (refer to FIG. 6A) may include the shielding patterns SHPA1-1 and SHPA2. The shielding patterns SHPA1-1 and SHPA2 may be spaced apart from each other. The first-first shielding pattern SHPA1-1 may be formed in an area corresponding to the first-first shielded pixel SHPX1-1 in the input sensor ISP, and the second shielding pattern SHPA2 may be formed in an area corresponding to the second shielded pixel SHPX2 in the input sensor ISP.

The first-first shielding pattern SHPA1-1 may partially overlap a first-first anode electrode AE1-1 included in the first-first shielded pixel SHPX1-1 in a plan view. The area where the first-first anode electrode AE1-1 overlaps the first-first shielding pattern SHPA1-1 may be defined as a first-first shielding area SHA1-1, and the area where the first-first anode electrode AE1-1 does not overlap the first-first shielding pattern SHPA1-1 may be defined as a first-first actual emissive area RPXA1-1. For example, the first-first shielding pattern SHPA1-1 may shield at least a portion of an area outside an emissive area PXA1-1 of the first-first shielded pixel SHPX1-1. In the first-first shielding area SHA1-1, light emitted by the first-first shielded pixel SHPX1-1 may be blocked by the first-first shielding pattern SHPA1-1. The light emitted by the first-first shielded pixel SHPX1-1 may be visible in the first-first actual emissive area RPXA1-1.

The second shielding pattern SHPA2 may overlap a second anode electrode AE2 included in the second shielded pixel SHPX2 in a plan view. The area where the second anode electrode AE2 overlaps the second shielding pattern SHPA2 may be defined as a second shielding area SHA2. For example, the second shielding pattern SHPA2 may entirely shield an emissive area of the second shielded pixel SHPX2. In the second shielding area SHA2, light emitted by the second shielded pixel SHPX2 may be blocked by the second shielding pattern SHPA2.

A second emissive area PXA2 may be defined to correspond to a partial region where a third electrode AE3 included in the non-shielded pixel SHPX3 is exposed by the opening OP7 of the pixel defining layer IL7. Since the shielding patterns SHPA1-1 and SHPA2 are not disposed over the third electrode AE3, light emitted by the non-shielded pixel SHPX3 may be visible through the second emissive area PXA2.

However, the disclosure is not limited thereto, and in another embodiment, the emissive area of the first-first shielded pixel SHPX1-1 may be entirely shielded by the first-first shielding pattern SHPA1-1, and only a portion of the emissive area of the second shielded pixel SHPX2 may be shielded by the second shielding pattern SHPA2.

Referring to FIGS. 10B and 11B, the input sensor ISP (refer to FIG. 6A) may include a first-second shielding pattern SHPA1-2 and a second shielding pattern SHPA2.

The second pixels PX2 (refer to FIG. 5B) may include a first-second shielded pixel SHPX1-2, a second shielded pixel SHPX2, and a non-shielded pixel SHPX3. In FIG. 10B, the first pixels PX1 and the second pixels PX2 on the display panel DP (refer to FIG. 5A) are illustrated by dotted lines, and the first-second shielding pattern SHPA1-2 and the second shielding pattern SHPA2 included in the input sensor ISP (refer to FIG. 6A) on the display panel DP are illustrated. The structures of the second shielded pixel SHPX2 and the non-shielded pixel SHPX3 of FIGS. 10B and 11B may be similar to the structures of the second shielded pixel SHPX2 and the non-shielded pixel SHPX3 of FIGS. 10A and 11A, and description thereabout will be omitted.

The input sensor ISP (refer to FIG. 6A) may include the shielding patterns SHPA1-2 and SHPA2. The shielding patterns SHPA1-2 and SHPA2 may be spaced apart from each other. The first-second shielding pattern SHPA1-2 may be formed in an area corresponding to the first-second shielded pixel SHPX1-2 in the input sensor ISP, and the second shielding pattern SHPA2 may be formed in an area corresponding to the second shielded pixel SHPX2 in the input sensor ISP.

The first-second shielding pattern SHPA1-2 may partially overlap a first-second anode electrode AE1-2 included in the first-second shielded pixel SHPX1-2 in a plan view. The area where the first-second anode electrode AE1-2 overlaps the first-second shielding pattern SHPA1-2 may be defined as a first-second shielding area SHA1-2, and the area where the first-second anode electrode AE1-2 does not overlap the first-second shielding pattern SHPA1-2 may be defined as a first-second actual emissive area RPXA1-2. For example, the first-second shielding pattern SHPA1-2 may shield at least a portion of an area inside an emissive area PXA1-2 of the first-second shielded pixel SHPX1-2. In the first-second shielding area SHA1-2, light emitted by the first-second shielded pixel SHPX1-2 may be blocked by the first-second shielding pattern SHPA1-2. The light emitted by the first-second shielded pixel SHPX1-2 may be visible in the first-second actual emissive area RPXA1-2.

However, the disclosure is not limited thereto, and in another embodiment, the emissive area of the first-second shielded pixel SHPX1-2 may be entirely shielded by the first-second shielding pattern SHPA1-2.

Although not illustrated in FIGS. 11A and 11B, the shielding patterns SHPA1-1, SHPA1-2, and SHPA2 may include a first sub-shielding pattern and a second sub-shielding pattern that have a double layer structure like the first shielding line SHL1 and the second shielding SHL2 illustrated in FIGS. 9B to 9D, and the first shielding line SHL1 may correspond to the first sub-shielding pattern, and the second shielding line SHL2 may correspond to the second sub-shielding pattern. The anode electrodes AE1-1, AE1-2, AE2, and AE3 may overlap at least one of the first sub-shielding pattern and the second sub-shielding pattern in a plan view.

According to an embodiment of the disclosure, the input sensor ISP (refer to FIG. 6A) may include the first and second shielding patterns SHPA1-1, SHPA1-2, and SHPA2 to shield the first and second shielded pixels SHPX1-1, SHPX1-2, and SHPX2 adjacent to the first corner DC1, thereby preventing the multi-step shaped pattern of the first corner DC1 from being visible. Thus, the electronic device ELD (refer to FIG. 1) with improved display quality may be provided.

According to an embodiment of the disclosure, the electronic device may include the shielding line or the shielding pattern that shields the pixels disposed in the multi-step shape at the corners of the display panel. Accordingly, the electronic device may prevent the multi-step shaped patterns at the corners of the display panel from being visible, thereby improving the overall display quality of the electronic device.

FIG. 12 is a schematic block diagram of an electronic device, according to an embodiment of the disclosure.

Referring to FIG. 12, an electronic device 601 may output various information through a display module 640 in an operating system. In case that a processor 610 executes an application stored in a memory 620, a display module 640 may provide application information to a user through a display panel 641.

The processor 610 may obtain an external input through an input module 630 or a sensor module 661 and execute an application corresponding to the external input. For example, in case that the user selects a camera icon displayed on the display panel 641, the processor 610 may obtain a user input through an input sensor 661-2 and activate a camera module 671. The processor 610 may deliver image data corresponding to a captured image obtained through the camera module 671 to the display module 640. The display module 640 may display an image corresponding to the captured image through the display panel 641.

For example, in case that personal information is authenticated on the display module 640, a fingerprint sensor 661-1 may obtain entered fingerprint information as input data. The processor 610 may compare input data obtained through the fingerprint sensor 661-1 with authentication data stored in the memory 620 and execute an application based on the comparison result. The display module 640 may display information, which is executed depending on the logic of the application, through the display panel 641.

For example, in case that a music streaming icon displayed on the display module 640 is selected, the processor 610 may obtain a user input through the input sensor 661-2 and activate the music streaming application stored in the memory 620. In case that a music play command is input by the music streaming application, the processor 610 may provide sound information corresponding to the music play command to the user by activating a sound output module 663.

The operation of the electronic device 601 has been briefly described above. Hereinafter, a configuration of the electronic device 601 will be described in detail. Some of components of the electronic device 601, which will be described below, may be integrated and provided as one configuration, or one configuration may be provided to be separated into two or more configurations.

Referring to FIG. 12, the electronic device 601 may communicate with an external electronic device 602 through a network (e.g., a short-range wireless communication network or a long-range wireless communication network). According to an embodiment, the electronic device 601 may include the processor 610, the memory 620, the input module 630, the display module 640, a power supply module 650, an embedded module 660, and an external module 670. According to an embodiment, in the electronic device 601, at least one of the above-described components may be omitted, or one or more other components may be added. According to an embodiment, some (e.g., the sensor module 661, an antenna module 662, or the sound output module 663) of the components described above may be integrated into another component (e.g., the display module 640).

The processor 610 may execute software to control at least another component (e.g., hardware or software component) of the electronic device 601 connected to the processor 610, and may process and calculate various types of data. According to an embodiment, as at least part of data processing or calculation, the processor 610 may store instructions or data received from other components (e.g., the input module 630, the sensor module 661 or a communication module 673) into a volatile memory 621, and may process instructions or data stored in the volatile memory 621. The result data may be stored in a nonvolatile memory 622.

The processor 610 may include a main processor 611 and an auxiliary processor 612. The main processor 611 may include one or more of a central processing unit (CPU) 611-1 and an application processor (AP). The main processor 611 may further include one or more of a graphic processing unit (GPU) 611-2, a communication processor (CP), and an image signal processor (ISP). The main processor 611 may further include a neural processing unit (NPU) 611-3. The NPU 611-3 may be a processor that is specialized in processing an artificial intelligence model. The artificial intelligence model may be generated through machine learning. The artificial intelligence model may include multiple artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, and a combination thereof, but the disclosure is not limited thereto. Additionally or alternatively, the artificial intelligence model may include a software structure. At least two of the processing units and the processors that are described above may be implemented as one integrated component (e.g., a single chip) or may be implemented as independent components (e.g., multiple chips).

The auxiliary processor 612 may include a driving controller 612-1. The driving controller 612-1 may include an interface converting circuit and a timing control circuit. The driving controller 612-1 may receive an image signal from the main processor 611, convert the data format of the image signal suitable for the interface specifications with the display module 640, and output image data. The driving controller 612-1 may output various control signals required to drive the display module 640.

The auxiliary processor 612 may further include a data converting circuit 612-2, a gamma correcting circuit 612-3, and a rendering circuit 612-4. The data converting circuit 612-2 may receive the image data from the driving controller 612-1 and may compensate the image data such that an image is displayed at a desired luminance according to characteristics of the electronic device 601 or setting of the user or may convert the image data to reduce power consumption or compensate for afterimages. The gamma correcting circuit 612-3 may convert the image data, a gamma reference voltage, or the like such that the image displayed on the electronic device 601 has desired gamma characteristics. The rendering circuit 612-4 may receive the image data from the driving controller 612-1 and may render the image data in consideration of a pixel arrangement of the display panel 641 applied to the electronic device 601. At least one of the data converting circuit 612-2, the gamma correcting circuit 612-3, and the rendering circuit 612-4 may be integrated into another component (e.g., the main processor 611 or the driving controller 612-1). At least one of the data converting circuit 612-2, the gamma correcting circuit 612-3, and the rendering circuit 612-4 may be integrated into a data driver 643.

The memory 620 may store various pieces of data, which are used by at least one component (e.g., the processor 610 or the sensor module 661) of the electronic device 601 and input data or output data for commands related thereto. The memory 620 may include at least one of the volatile memory 621 and the nonvolatile memory 622.

The input module 630 may receive, from the outside (e.g., the user or an external electronic device 602) of the electronic device 601, commands or data to be used in a component (e.g., the processor 610, the sensor module 661, or the sound output module 663) of the electronic device 601.

The input module 630 may include a first input module 631, through which the commands or data are input from the user, and a second input module 632 through which the commands or data are input from the external electronic device 602. The first input module 631 may include a microphone, a mouse, a keyboard, a key (e.g., a button), or a pen (e.g., a passive pen or an active pen). The second input module 632 may support a designated protocol capable of being connected to the external electronic device 602 by wire or wirelessly. According to an embodiment, the second input module 632 may include a high definition multimedia interface (HDMI), a universal serial bus (USB) interface, a secure digital (SD) card interface, or an audio interface. The second input module 632 may include a connector that may be physically connected to the external electronic device 602, for example, an HDMI connector, a USB connector, an SD card connector, or an audio connector (e.g., a headphone connector).

The display module 640 may provide visual information to the user. The display module 640 may include the display panel 641, a scan driver 642, and the data driver 643. The display module 640 may further include a window, a chassis, a bracket, or the like for protecting the display panel 641. The display module 640 may further include a light emitting driver, a voltage generator, and the like. The voltage generator may output various voltages required to drive the display panel 641.

The power supply module 650 may supply power to the components of the electronic device 601. The power supply module 650 may include a battery that charges a power voltage. The battery may include a non-rechargeable primary cell, a rechargeable secondary cell, a fuel cell, or the like. The power supply module 650 may include a power management integrated circuit (PMIC). The PMIC may supply optimized power to the above-described modules and modules which will be described below. The power supply module 650 may include a wireless power transmission/reception member electrically connected to the battery. The wireless power transmission/reception member may include multiple coil-shaped antenna radiators.

The electronic device 601 may further include the embedded module 660 and the external module 670. The embedded module 660 may include the sensor module 661, the antenna module 662, and the sound output module 663. The external module 670 may include the camera module 671, a light module 672, and the communication module 673.

The sensor module 661 may detect an input from the user's body or an input from a pen among the first input module 631, and may generate an electrical signal or data value corresponding to the input. The sensor module 661 may include at least one of the fingerprint sensor 661-1, the input sensor 661-2, and a digitizer 661-3.

The fingerprint sensor 661-1 may generate a data value corresponding to a fingerprint of the user. The fingerprint sensor 661-1 may include at least one of an optical-type fingerprint sensor and a capacitance-type fingerprint sensor.

The input sensor 661-2 may generate a data value corresponding to coordinate information of an input by a body of the user or an input by a pen. The input sensor 661-2 may generate the change in capacitance due to the input as the data value. The input sensor 661-2 may sense an input by a passive pen or may transmit or receive data to or from an active pen.

The input sensor 661-2 may measure a biometric signal such as blood pressure, moisture, or body fat. For example, in case that the user touches a part of the body to a sensor layer or sensing panel and does not move for a specific period, the input sensor 661-2 may detect the biometric signal and may output information desired by the user to the display module 640 based on a changes in electric fields caused by the part of the body.

The digitizer 661-3 may generate the data value corresponding to coordinate information of an input by the pen. The digitizer 661-3 may generate an electromagnetic change amount due to the input as the data value. The digitizer 661-3 may sense input by the passive pen or transmit or receive data to or from the active pen.

At least one of the fingerprint sensor 661-1, the input sensor 661-2, and the digitizer 661-3 may be implemented as a sensor layer formed on the display panel 641 through a subsequent process. The fingerprint sensor 661-1, the input sensor 661-2, and the digitizer 661-3 may be placed on the upper side of the display panel 641, and one (e.g., the digitizer 661-3) of the fingerprint sensor 661-1, the input sensor 661-2, and the digitizer 661-3 may be placed on the lower side of the display panel 641.

At least two of the fingerprint sensor 661-1, the input sensor 661-2, and the digitizer 661-3 may be formed to be integrated into one sensing panel through a same process. In case of being integrated into one sensing panel, the sensing panel may be placed between the display panel 641 and a window placed on the upper side of the display panel 641. According to an embodiment, the sensing panel may be placed on a window, but the location of the sensing panel is not particularly limited thereto.

At least one of the fingerprint sensor 661-1, the input sensor 661-2, and the digitizer 661-3 may be built in the display panel 641. For example, at least one of the fingerprint sensor 661-1, the input sensor 661-2, and the digitizer 661-3 may be simultaneously formed through a process of forming elements (e.g., a light emitting element, a transistor, or the like) included in the display panel 641.

The sensor module 661 may generate an electrical signal or a data value corresponding to the internal state or external state of the electronic device 601. For example, the sensor module 661 may further include a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illumination sensor.

The antenna module 662 may include one or more antennas to transmit or receive signal or power to or from an external source. According to an embodiment, the communication module 673 may transmit or receive the signal to or from the external electronic device through the antenna suitable for a communication method. An antenna pattern of the antenna module 662 may be integrated into the input sensor 661-2 or one component (e.g., the display panel 641) of the display module 640.

The audio output module 663 may be a device for outputting an audio signal to the outside of the electronic device 601 and, for example, may include a speaker used for general purposes, such as multimedia playback or recording playback, and a receiver used only for receiving a call. According to an embodiment, the receiver may be implemented separately from the speaker or may be integrated with the speaker. A sound output pattern of the sound output module 663 may be integrated into the display module 640.

The camera module 671 may shoot a still image or a video image. According to an embodiment, the camera module 671 may include one or more lenses, an image sensor, or an image signal processor. The camera module 671 may further include an infrared camera capable of detecting the presence or absence of the user, a position of the user, a gaze of the user, or the like.

The light module 672 may provide light. The light module 672 may include a light emitting diode or a xenon lamp. The light module 672 may operate in conjunction with the camera module 671 or may operate independently from the camera module 1710.

The communication module 673 may support establishing a wired or wireless communication channel between the electronic device 601 and the external electronic device 602 and performing communication through the established communication channel. The communication module 673 may include at least one of wireless communication modules such as a cellular communication module, a short-range wireless communication module, or a global navigation satellite system (GNSS) communication module, and wired communication modules such as a local area network (LAN) communication module or a power line communication module. The communication module 673 may communicate with the external electronic device 602 through a short-range communication network such as Bluetooth, WiFi direct, or infrared data association (IrDA) or a long-range communication network such as a cellular network, Internet, or a computer network (e.g., the LAN or a wide area network (WAN)). The above-mentioned various communication modules 673 may be implemented into one chip or may be respectively implemented into separate chips.

The input module 630, the sensor module 661, the camera module 671, and the like may be utilized to control an operation of the display panel 640 in conjunction with the processor 610.

The processor 610 may output commands or data to the display module 640, the sound output module 663, the camera module 671, or the light module 672 based on input data received from the input module 630. For example, the processor 610 may generate image data in response to input data applied through a mouse, an active pen, or the like to output the generated image data to the display module 640 or may generate command data in response to the input data to output the generated command data to the camera module 671 or the light module 672. In case that no input data is received from the input module 630 for a specific period, the processor 610 may switch an operation mode of the electronic device 601 to a low-power mode or a sleep mode to reduce power consumed in the electronic device 601.

The processor 610 may output commands or data to the display module 640, the sound output module 663, the camera module 671, or the light module 672 based on sensing data received from the sensor module 661. For example, the processor 610 may compare authentication data authorized by the fingerprint sensor 661-1 with the authentication data stored in the memory 620, and may execute an application depending on the comparison result. The processor 610 may execute commands or may output corresponding image data to the display module 640 based on sensing data sensed by the input sensor 661-2 or the digitizer 661-3. In case that the sensor module 661 includes a temperature sensor, the processor 610 may receive temperature data regarding the measured temperature from the sensor module 661 and may further perform luminance correction on image data based on the temperature data.

The processor 610 may receive measurement data regarding the presence or absence of the user, the user's location, and the user's gaze from the camera module 671. The processor 610 may further perform luminance correction on the image data based on the measurement data. For example, the processor 610 that determines the presence or absence of the user through an input from the camera module 671 may output image data, of which the luminance is corrected, to the display module 640 through the data converting circuit 612-2 or the gamma correcting circuit 612-3.

Some of the components may be connected to each other through a communication method between peripheral devices, for example, a bus, a general purpose input/output (GPIO), a serial peripheral interface (SPI), a mobile industry processor interface (MIPI), or an ultra-path interconnect (UPI) link and may exchange a signal (e.g., commands or data) between each other. The processor 610 may communicate with the display module 640 through an interface, and for example, may use any one of the above-described communication methods, but the disclosure is not limited to the above-described communication methods.

The electronic device 601 according to various embodiments disclosed in the specification may be implemented with various types of devices. The electronic device 601 may include, for example, at least one of a portable communication device (e.g., a smart phone), a computer device, a portable multimedia device, a portable medical device, a camera, a wearable device, and a home appliance. The electronic device 601 is not limited to the above-described devices.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. An electronic device comprising:
a display layer including a first display area in which a plurality of first pixels are disposed and a second display area in which a plurality of second pixels are disposed;
a drive circuit that overlaps the second display area in a plan view; and
a sensor layer disposed on the display layer, the sensor layer comprising a sensing area and a non-sensing area,
wherein the sensor layer includes:
a plurality of sensing electrodes disposed in the sensing area; and
a shielding line that commonly overlaps some of the plurality of second pixels adjacent to a corner of the second display area in a plan view and is disposed in the non-sensing area.

2. The electronic device of claim 1, wherein the sensor layer further includes an antistatic line disposed in the non-sensing area.

3. The electronic device of claim 2, wherein the shielding line has a shape corresponding to the corner.

4. The electronic device of claim 3, wherein the shielding line extends from the antistatic line.

5. The electronic device of claim 3, wherein the shielding line is a portion of the antistatic line.

6. The electronic device of claim 1, wherein
the plurality of second pixels constitute a pixel cell, and
the shielding line has a blocking width corresponding to a size of the pixel cell.

7. The electronic device of claim 1, wherein
the plurality of second pixels constitute a pixel unit, and
the shielding line has a blocking width corresponding to a size of the pixel unit.

8. The electronic device of claim 1, wherein
the shielding line includes:
a first shielding line; and
a second shielding line disposed on the first shielding line, and
the plurality of second pixels overlap at least one of the first shielding line and the second shielding line in a plan view.

9. The electronic device of claim 8, wherein
the sensor layer further includes an intermediate insulating layer between the first shielding line and the second shielding line, and
the intermediate insulating layer is formed of an organic material or an inorganic material.

10. The electronic device of claim 9, wherein the first shielding line and the second shielding line partially overlap each other in a plan view.

11. The electronic device of claim 8, wherein
the second shielding line is directly disposed on the first shielding line,
the sensor layer further includes an intermediate insulating layer that covers the second shielding line, and
the intermediate insulating layer is formed of an organic material or an inorganic material.

12. The electronic device of claim 1, wherein
the plurality of sensing electrodes include:
a plurality of first sensing electrodes extending in a first direction; and
a plurality of second sensing electrodes extending in a second direction intersecting the first direction, and
the sensor layer further includes:
a plurality of first trace lines electrically connected with the plurality of first sensing electrodes; and
a plurality of second trace lines electrically connected with the plurality of second sensing electrodes.

13. The electronic device of claim 12, wherein at least one of the plurality of first trace lines and the plurality of second trace lines is disposed in the sensing area.

14. An electronic device comprising:
a display layer including a first display area in which a plurality of first pixels are disposed and a second display area in which a plurality of second pixels are disposed;
a drive circuit that overlaps the second display area in a plan view; and
a sensor layer disposed on the display layer, the sensor layer comprising a sensing area and a non-sensing area, wherein
the sensor layer includes a plurality of shielding patterns spaced apart from one another,
the plurality of second pixels are adjacent to a corner of the second display area and include shielded pixels overlapping the plurality of shielding patterns in a plan view and a non-shielded pixel not overlapping the plurality of shielding patterns in a plan view,
each of the shielded pixels includes an emissive area and a non-emissive area, and
each of the plurality of shielding patterns shields at least a portion of the emissive area of the shielded pixels.

15. The electronic device of claim 14, wherein the each of the plurality of shielding patterns shields an area outside the emissive area of the shielded pixels.

16. The electronic device of claim 14, wherein the each of the plurality of shielding patterns shields an area inside the emissive area of the shielded pixels.

17. The electronic device of claim 14, wherein the each of the plurality of shielding patterns entirely shields the emissive area of the shielded pixels.

18. The electronic device of claim 14, wherein the sensor layer further includes an antistatic line disposed in the non-sensing area.

19. The electronic device of claim 14, wherein
the sensor layer further includes a plurality of sensing electrodes disposed in the sensing area,
the plurality of sensing electrodes include:
a plurality of first sensing electrodes extending in a first direction; and
a plurality of second sensing electrodes extending in a second direction intersecting the first direction, and
the sensor layer further includes:
a plurality of first trace lines electrically connected with the plurality of first sensing electrodes; and
a plurality of second trace lines electrically connected with the plurality of second sensing electrodes.

20. The electronic device of claim 19, wherein at least one of the plurality of first trace lines and the plurality of second trace lines is disposed in the sensing area.
